(19) United States
(12) Patent Application Publication
(10) Pub. No.: US 2020/0128271 A1
(43) Pub. Date: Apr. 23, 2020

(54) METHOD AND SYSTEM OF MULTIPLE CHANNEL VIDEO CODING WITH FRAME RATE VARIATION AND CROSS-CHANNEL REFERENCING

(71) Applicant: INTEL CORPORATION, Santa Clara, CA (US)

(72) Inventor: Jason Tanner, Folsom, CA (US)

(73) Assignee: INTEL CORPORATION, Santa Clara, CA (US)

(21) Appl. No.: 16/722,140

(22) Filed: Dec. 20, 2019

(51) Int. Cl. H04N 19/52; H04N 19/172; H04N 19/577; H04N 19/114; H04N 19/573

(52) U.S. Cl. CPC H04N 19/52; H04N 19/172; H04N 19/573; H04N 19/114; H04N 19/577

(57) ABSTRACT

Techniques related to video coding include multiple channel video coding with varying frame rates and cross-channel referencing.

### BACKGROUND

In video compression and/or decompression (codec) systems, compression efficiency and video quality are important performance criteria. For example, visual quality is an important aspect of the user experience in many video applications and compression efficiency impacts the amount of memory storage needed to store video files and/or the amount of bandwidth needed to transmit and/or stream video content. A video encoder compresses video information so that more information can be sent over a given bandwidth or stored in a given memory space or the like. The compressed signal or data is then decoded by a decoder that decodes or decompresses the signal or data for display to a user. In most implementations, higher visual quality with greater compression is desirable.

In some contexts, large online video providers have large video collections that are encoded such that each video (e.g., each piece of content) when requested by a user is encoded in multiple resolutions, bitrates, frame rates, etc. For example, a streaming video service may encode a single original input video with an output bitstream having a 4K resolution with a frame rate of 60 frames per second (fps) (referred to as 4k60), 1080p resolution with a frame rate of 60 fps (1080p60), 1080p resolution with a frame rate of 30 fps (1080p30), 720p resolution with a frame rate of 30 fps (720p30), 480p resolution with a frame rate of 30 fps (480p30), and so on with all of those resolutions encoded at, for example, 10 different bitrates. By one example, the 4k60 content can be transcoded to different bitrates and frame rates at 4k60, 1080p60, 1080p30, 1080p24, 720p30. This is known as multiple stream encode where one input video source is encoded to output bitstreams or videos with multiple resolutions, bitrates, and/or frame rates.

The streaming experience, however, can often be inadequate when performance and quality are not properly balanced due to changes in frame rate from video channel to video channel. Specifically, the performance and quality enhancements from one video channel can be used on corresponding or concurrent frames of another video channel. Thus, when providing enhancements from a video channel with a lower frame rate (say 30 fps) to one with a higher frame rate (say 60 fps), the encoder cannot use the enhancements on the additional frames in the higher frame rate channel that do not have a corresponding frame in the low frame rate channel, thereby limiting increased performance and/or quality on the higher frame rate channel.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of frames of multiple video channels using cross-channel referencing;

FIG. 2 is a schematic diagram of an example system for coding an original video to multiple independent bitstreams using cross-channel referencing according to at least one of the implementations herein;

FIG. 3 is a schematic diagram of an encoder according to at least one of the implementations herein;

FIG. 4 is an example method of multiple channel video coding with frame rate variation and cross-channel referencing according to at least one of the implementations herein;

FIGS. 5A-5D is a detailed example method of video coding with frame rate variation and cross-channel referencing according to at least one of the implementations herein;

FIG. 6A is a schematic diagram of frames of multiple video channels using cross-channel referencing with an interpolation strategy to compensate for frame rate variation according to at least one of the implementations herein;

FIG. 6B is a schematic diagram of frames of multiple video channels using cross-channel referencing with a probabilistic strategy to compensate for frame rate variation according to at least one of the implementations herein;

FIG. 7 is a schematic diagram of a non-concurrent frame showing intra-prediction blocks according to at least one of the implementations herein;

FIG. 8 is a schematic diagram of a non-concurrent frame showing undersampling and oversampling according to at least one of the implementations herein;

FIG. 9 is a schematic diagram of a concurrent frame according to at least one of the implementations herein;

FIG. 10 is a schematic diagram of another concurrent frame according to at least one of the implementations herein;

FIG. 11 is a schematic diagram of a non-concurrent frame between the concurrent frames of FIGS. 9 and 10 according to at least one of the implementations herein;

FIG. 12 is an illustrative diagram of an example system;

FIG. 13 is an illustrative diagram of another example system; and

FIG. 14 illustrates an example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, tablets, televisions, computers, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as DRAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Methods, devices, apparatuses, systems, computing platforms, and articles described herein are related to video coding and, in particular, to multiple channel video coding with frame rate variation and cross-channel referencing.

As mentioned above, it may be advantageous to encode large batches of videos such that a particular video (e.g., a particular piece of video content) is encoded in multiple resolutions, bitrates, and frame rates, as well as other parameters. For transcoding on a server for example, a system often encodes a video stream with multiple resolutions and at multiple bitrates and multiple frame rates for each resolution. By one example, certain media services operate in adaptive bit-rate (ABR) mode that requires storage of multiple instances (video sequences) of the same original video being transcoded on separate channels or encoders and from the original sequence provided by the content creator. For instance, a video streaming internet service may store multiple bitrates and frame rates of a video at 4k and multiple bitrates and frame rates of the same video of 1080p, plus it may even use different encoding options to generate output for the different resolutions. As the internet connection changes to adjust the bandwidth higher or lower, the service will switch from one bitrate, frame rate, and/or resolution to another bitrate, frame rate, and/or resolution to optimize the viewing experience for the end user.

Traditionally, however, each encode is handled independently on a separate channel with a separate encoder. This results in inefficient performance due to duplication of effort from individual video sequence to video sequence (or channel to channel). Specifically, encoding decisions on one video sequence (say the 4K sequence) may review 100 different ways to perform intra or inter-prediction on a certain frame but narrows the choices down to three possible ways that are the most likely to provide a good quality image. Another channel, say a 1080p channel of the same frame, will need to separately make this same determination with the same or similar input image data of the frame. If one channel or encoder could provide data that indicates previously made decisions or parameter settings that can be used at another channel or encoder, this would significantly reduce the computational load to make these decisions on the latter channel, and in turn reduce the time to make these decisions thereby increasing performance.

Accordingly, it has been found that adjustments to the encoding that improve a balance between performance and quality can be established by creating dependencies between the video sequences of different resolutions, frame rates, and/or bitrates (or other parameter differences). By one cross-channel referencing system, this involves referencing encoding parameters of a video sequence with a certain resolution and bitrate to be used by an encode for a video sequence with a different resolution and/or bitrate (or other parameter). Such referencing at least significantly reduces the number of alternatives to analyze to form an encoding processing decision such as for inter or intra prediction for example, thereby reducing the time and computational load of such decisions. Such a system is disclosed by U.S. patent application Ser. No. 16/369,937, filed Mar. 29, 2019 and published as U.S. Patent Publication No. US 2019-0230365 (herein referred to as the '937 application), and 16/582,975, filed Sep. 25, 2019 and published as U.S. Pat. Publication Ser. No. ______ (herein referred to as the '975 application), which are incorporated herein for all purposes.

In more detail, such a cross-channel referencing system optimizes 1:N transcoding whether N refers to resolutions or bitrates to enhance performance. For video channels with the same frame rate, these performance gains result in about 30% to 50% performance improvement for the encoder portion of a transcode operation without significantly reducing quality for example. This is accomplished by transmitting the decisions and heuristics from one encode unit for one bitstream format to a second encode unit for another bitstream format to reduce the time spent making encoding decisions for the second encode unit and by focusing on the most likely candidates and other parameters already used on one of the other channels. This may be performed on a block-by-block basis or other processing partition unit. For example, such decisions and heuristics that form cross-channel encode controls to be provided for a video sequence (or channel or encoder) from a different video sequence (or channel or encoder) may relate to selection of a cross-channel block size considering a first input resolution to provide the cross-channel rules block by block (or on a block level), a coding prediction mode (e.g., inter, intra, skip, merge), a motion vector, an intra mode, a coding unit partitioning of the cross-channel block (i.e., defining the coding unit sizes and shapes within the cross-channel block), and/or transform unit depth or partitioning of the cross-channel block (i.e., defining the sizes and shapes of transform units for the cross-channel block), and so forth.

The encode controls are formed by translating coding parameters at the first resolution and the first bitrate from the first encode to be used to encode the video at a second resolution or a second bitrate. As used herein, the term encode controls includes any data structure or indicators that restrict encode decisions by setting the encode decision (such that the decision is not evaluated at the encode but is simply used) or by setting a restriction that limits evaluation of options or candidates at the encode. Likewise, the term restriction to encode decisions indicates the encode will be defined by the restriction (e.g., the restriction is used directly) or the encode will be modified by the restriction (e.g., the restriction is used to limit the number of encode options to be evaluated, searched, etc.).

For example, such limits on evaluation may restrict block evaluation to only intra modes (while inter modes are not checked), to only inter modes (while intra modes are not checked), to only particular types of intra modes, to motion search only within a confined region around a motion vector or to only fractional motion vector search around an integer motion vector, to only evaluating particular partitions of a block (such as block sizes) for coding mode evaluation, to only evaluating particular transform unit split depths (e.g., only particular partitions of coding units for best transform unit size), and so on. Such encode controls may be generated from a first processing partition (such as a block) in the first encode and translated for use by a second partition in the second encode that corresponds to the first partition. As used herein the term corresponding with respect to blocks, for example, indicates the blocks are fully or partially spatially collocated in their respective frames (scaled as needed when the video size has been scaled) and temporally collocated in their respective videos. This arrangement described thus far is disclosed by the '937 patent application cited above.

Also in some cases, the cross-channel referencing system mentioned above assumes the quantization parameter (QP) is the same or similar from channel to channel. In a more sophisticated approach, however, the cross-channel referencing system matches one or more source video sequences or channels to one or more receiving or sink video sequences or channels depending on a bitrate-related value of each channel, such as the QP. The system shares encode restrictions and controls from source to sink when it is found that the QPs are sufficiently close between the channels. This arrangement is disclosed by the '975 patent application cited above.

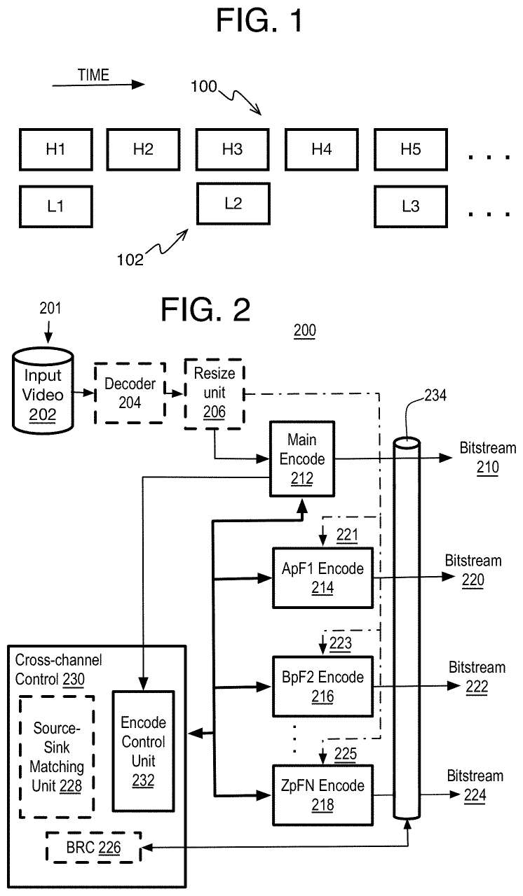

Referring now to FIG. 1, more difficulties arise when attempting to provide performance and quality enhancements, in the form of the encode controls for example, from a channel with a relatively low frame rate to a channel with a relatively high frame rate. For example, a first channel 100 with a higher frame rate may have a video sequence with frames H1 to H5 at 60 fps for example and as shown in encoding order. Subsequent frames may be added as time passes from left to right. A second channel 102 with a lower frame rate may have frames L1 to L3 also in time from left to right as shown. With mismatched frame rates, only some frames of the higher frame rate channel 100 have frames (frames H1, H3, and H5) concurrent with frames on the lower frame rate channel 102 such as with frames L1 to L3 respectively. Concurrent here may refer to a frame that has the same time stamp (or time difference) relative to a time stamp of a start or designated anchor frame of a video sequence for example. Alternatively, concurrent may refer to the same number of frames in a count of frames from a start or anchor frame of a video sequence. Otherwise, those frames that are concurrent may be the closest frames to each other in time and from different channels than any other frame in those channels. In the present example then, every other frame in the higher frame rate channel 100 has a concurrent frame in the lower frame rate channel 102.

In order to increase the quality and/or performance of the high frame rate channel 100, the cross-channel technique described above uses the encoder settings from the frames L1 to L3 to provide encode controls to concurrent frames H1, H3, and H5 respectively. For these concurrent frames H1, H3, and H5, their performance may be increased by 30-50% as mentioned above, and when only considering the concurrent frames.

The non-concurrent frames H2 and H4 of high frame rate channel 100, however, cannot take advantage of the encoder settings in the low frame rate channel 102. Only concurrent frames can take advantage of the encoder settings in the other channel because even a small amount of motion from frame to frame will require different sizes and positions of prediction blocks that significantly affect the motion vectors, inter-prediction modes, and intra prediction modes such that visible artifacts can be generated if encoder controls are obtained from non-concurrent frames. Thus, the encoders turn off the cross-channel encoder control operations for the non-concurrent frames H2 and H4. In these cases, the total effective cross-channel performance increase falls to 15-25% for the high frame rate video sequence channel.

One attempt at a solution could be to repurpose the coding decisions from two prior consecutive frames (such as frames H2 and H3) in encoding order to be used as reference frames for enhancement of frame H4. In this case, the image data resulting from encoder controls applied to frame pair H2 and H3 may be used to directly interpolate candidate modes for frame H4. For example, if the reference pair has respective motion vectors (MVa and MVb) for the same block location and to whatever reference frame is used according to a group of pictures for encoding, then generally the interpolation is (MVa+MVb)/2. Otherwise, each reference frame being used here may provide separate prediction candidates. In either case, however, it has been found that the analysis is insufficient, and the coding unit (CU) block sizes still misalign due to the frame to frame motion. This also has a potential negative visual quality impact such as providing blocks that are too large for an area that might need a smaller block because large blocks result in larger residuals, and in turn, a correspondingly larger transform with less detail than that of smaller transforms. This can result in visual issues (e.g. a star disappearing from an image of a sky). Thus, when a poor mode decision is made by setting too large a prediction block, this may result in an overly large amount of coefficient bits of the DCT and quantization to compensate for the errors in those areas.

To resolve these issues, the disclosed methods enhance the reconstruction of non-concurrent frames of the higher frame rate channel by using prediction or reconstructed data of the concurrent frames already based on encode controls from the lower frame rate channel. This indirectly applies the performance enhancements from the encode controls to the non-concurrent frames. This indirect use of the encode controls can be accomplished in at least two different strategies or techniques. One of these techniques is a probabilistic method which uses frames that are prior to the non-concurrent frame in encoding order so that these claims already have their encode control influenced prediction data either directly as a concurrent frame or indirectly as a prior non-concurrent frame, referred to herein as encode control (EC) reference frames. By one approach, the non-concurrent frame is in between these two EC reference frames, and are consecutive with the two EC reference frames, in display order so that image data blocks of the non-concurrent frame forms an intermediate block motion position between block positions on the two EC reference frames. While one of the EC reference frames should be a designated reference frame in a group of pictures (GOPs) setting for the encoder, the other EC reference frame of the pair may or may not be such a designated reference frame. For example, with a typical GOP with I-frames, P-frames, and B-frames in an IPBB encoding order or I, P, B1, B2. The B2 frame may have P and B1 as its EC reference frames even though the designated GOP reference frames for B2 is I and P. The display order is I, B1, B2, P so that the result is analysis of block motion very close to the non-concurrent frame by using the two adjacent frames next to the non-concurrent frame in display order.

To reduce the likelihood of poor performance predictions on the non-concurrent frame then, the probabilistic method includes setting an intermediate region on the non-concurrent frame that indicates motion of blocks from one of the EC reference frames to the other EC reference frame. Higher probability prediction modes to be used on this intermediate region then can be set with knowledge as to the motion of the blocks in the region.

Another technique to encode the non-concurrent frames is an interpolative method that is more accurate, but more compute intensive, than the probabilistic method. The interpolative method adjusts EC prediction data of the EC reference frames to be used by the non-concurrent frame, such as by adjusting motion vector lengths that indicate motion between the EC reference frames, and then using the shortened motion vectors as the prediction data of blocks on the non-concurrent frame. These motion vectors may be different than the motion vectors used to actually encode the EC reference frames which uses different reference frames as mentioned above.

A decision as to which method to use may be based on the complexity of the content in the video where the encoder enhances the non-concurrent frames having less complex content by using the probabilistic method while the encoder enhances the non-concurrent frames having more complex content by using the interpolation method in order to attempt to maintain performance at a high level. Specifically, the probabilistic method works best for low motion areas on the frame. This method may be based on a global motion model, such as a pan that assumes most motion on a frame is the same. In this case, prediction modes are used that are more accurate with higher performance for low motion, less complex areas on in the image content on the frame.

This technique, however, has difficulty handling large amounts of motion with complex image data. Specifically, the probabilistic technique has limited effectiveness when a large amount of motion is present, especially in multiple directions, which results in too many blocks with low probability prediction modes requiring a greater amount of candidate prediction modes to be checked. Thus, the interpolative method is provided to handle large amounts of motion better by forming a more accurate interpolation of the motion for the blocks.

By one form, interpolation is performed first, and when a block is undersampled such that it has no incoming interpolated motion vector on the non-concurrent frame indicating motion, then the probabilistic method is used on that block instead of the interpolation. Otherwise, the interpolation is used. This may be applied on a block by block basis or on a frame basis depending on the number of undersampled blocks on a frame. With these techniques, the increased performance gives a gain of 30 to 50% for the entire video sequence including both the concurrent and the non-concurrent frames.

Referring now to FIG. 2, an example system 200 for coding a video to multiple independent bitstreams or videos is arranged in accordance with at least some implementations of the present disclosure. By one form, the system 200 may be a transcoding device at a server or other computing device that can receive and transmit videos 201. When device 200 is a transcoder, an input video buffer 202 may receive a compressed video 201, and a decoder 204 may decompress the video 201 to provide a decompressed video for encoding. By other forms, system 200 is an encoding device that receives decompressed data from a remote decoder 204 or from a different device such as a camera generating image data and providing the data directly to system 200. Thus, system 200 may be implemented via any suitable device such as, for example, a server, a personal computer, a laptop computer, a tablet, a phablet, a smart phone, a digital camera, a gaming console, a wearable device, a television, a display device, an all-in-one device, a two-in-one device, or the like. For example, as used herein, a system, device, computer, or computing device may include any such device or platform.

The system 200 may receive video in many different resolutions such as 4K video 201 (or video at any suitable resolution). Video 201 may include any video sequence for encode. Such video may include any suitable video frames, video pictures, sequence of video frames, group of pictures, groups of pictures, video data, or the like in any suitable resolution. For example, the video may be video graphics array (VGA), high definition (HD), Full-HD (e.g., 1080p), or 4K resolution video, or the like, and the video may include any number of video frames, sequences of video frames, pictures, groups of pictures, or the like. The encoding techniques used herein may be performed by using frames, blocks, and sub-blocks, and so forth of pixel samples (typically square or rectangular) in any suitable color space such as YUV. Frames may be characterized as pictures, images, video pictures, sequences of pictures, video sequences, etc. For example, a picture or frame of color video data may include a luminance plane or component and two chrominance planes or components at the same or different resolutions with respect to the luminance plane. The video may include pictures or frames that may be divided into blocks of any size as described below, which contain data corresponding to blocks of pixels. Such blocks may include data from one or more planes or color channels of pixel data.

A non-compressed version of the input video 201 may be provided from the decoder 204, when provided, and to a resizing unit 206 that generates multiple video sequences (or units) each to form an independent bitstream. The resizing unit 206 may include a downsampler for downsizing image data and performs scaling techniques to change the resolution of a main or default video sequence with one resolution (main size), say 4K at 60 fps for main encode 212. The resizing unit 206 also may then generate any number of additional video sequences (or just videos) including resolutions A to Z for example, such as 1080p, 720p, 480p, and so forth, and with frame rates F1 to FN, including 30 fps and 60 fps. The resizing unit is shown here to provide videos (or video sequences) 221, 223, and 225 respectively to encoders 214, 216, and 218. The resizing unit 206 also may have an upsampling unit for upscaling the image data when needed as well.

An encoder may be provided for at least each different resolution, such as for one example, a 4K encoder unit (or main encode unit) 212, a 1080p encoder unit (or encode unit ApF1) 214, a 720p encoder unit (or encode unit BpF2) 216, and any other number of encoders to encode unit (ZpFN) 218 which may be a 480p encoder. Here, the same encoder may handle videos of different frame rates. Thus, encoder 214 could handle both F1 (60 fps) and F2 (30 fps). But by other options, each frame rate for the same resolution could have its own encoder as well. Thus, encoder 212 may be 4K60, while encoder 214 is 1080p60, encoder 216 is 1080p30, and so on to encoder 480p30 as encoder 218. These are random examples and any suitable resolutions and frame rate combinations may be used. Furthermore, encode units for the encode of differing bitrates, and other parameters also may be employed. Each of 4K60 encode unit 212, 1080p60 encode unit 214, 1080p30 encode unit 216, and 480p30 as encoder 218 are illustrated separately for the sake of clarity. However, such modules or units may be implemented in the same or different encode software, hardware, firmware, etc. Notably, the encodes performed by encode unit 214, 216, and 218 may be performed at least partially simultaneously using different units or multiplexed and context switched on the same hardware, or they may be performed serially using the same or different modules.

Encoders 212, 214, 216, and 218 and their corresponding output bitstreams 210, 220, 222, and 224 may be compatible with a video compression-decompression (codec) standard such as, for example, HEVC (High Efficiency Video Coding/H.265/MPEG-H Part 2), although the disclosed techniques may be implemented with respect to any codec such as AVC (Advanced Video Coding/H.264/MPEG-4 Part 20), VVC (Versatile Video Coding/MPEG-I Part 3), VP8, VP9, Alliance for Open Media (AOMedia) Video 2 (AV1), the VP8NP9/AV1 family of codecs, and so forth.

The system 200 also has a cross-channel control 230 with an encode control unit 232, and optionally with a source-sink matching unit 228 and a bitrate control unit (BRC) 226. The encode control unit 232 may translate the coding parameters of the main video (or source sequences) to be used to reduce the decision alternatives at the other videos (or sink sequences). The details of these operations are provided by U.S. patent application Ser. No. 16/369,937 cited above, which is incorporated herein and need not be explained in detail here. Generally, the translation operations may include first providing coding parameters, which may be provided at a block level, from the main encode unit 212. The encode control unit 232 then uses the coding parameters to generate one or more encode controls for differing resolutions, bitrates, frame rates, etc. Coding control may be translated, including scaling, from one resolution to that compatible with another resolution in many different combinations of resolutions. By one form, the encode control unit 232 may create a surface (i.e., one of block level coding controls) per coding unit (CU) level in a new resolution with encode controls for the encoding enhancement of the lower resolution encode. Such enhancements improve the performance and quality balance of the encode at lower resolutions. In addition to the performance improvements, the visual quality can also be enhanced through more accurately capturing the true motion and/or characteristics of the video.

The encode controls are then used to encode the same video at a sink or second resolution, bitrate, and/or frame rate to generate a second bitstream by encode unit 214, 216, or 218 for example. Notably, the sink bitstream is independent of the initial or first bitstream of encode unit 212 such that the entirety of the sink bitstream is sufficient to decode the video at the sink resolution, bitrate, and frame rate. That is, the sink bitstream does not need to rely in any way on the source bitstream for decode of the video to generate a bitstream. However, the encode controls received from another video sequence helps to improve performance and/or quality of the sink bitstream. Furthermore, as discussed, the source or first and sink or second bitstreams represent the same video content such that the same video (at different resolutions, bitrates, and/or frame rates) may be independently decoded using the source and sink bitstreams. Also, each of the encoders 212, 214, 216, 218 may have other units to perform the encoding described below with an encoder 300 and to provide the non-concurrent frame encoding described herein.

By another option, the cross-channel control 230 may have a source-sink matching unit 220 that determines the differences in bitrate-related values of each video sequence of the same frame, and then determines which video streams should be source sequences and which video streams should be sink sequences while attempting to minimize the number of source sequences. For this option, a bitrate control (BRC) unit 226 also may be provided to set the QP so that the encoding meets the bitrate set by other transmission applications and for the output bitstreams generated at each encoder 212, 214, 216, and 218. The BRC 226 monitors an output buffer 234 that is either partitioned to provide an output buffer for each encode unit 212, 214, 216, 218, or a separate output buffer 234 may be provided for each encode unit 212, 214, 216, 218. The BRC 226 raises or lowers the QP for a frame of the video sequence depending on the varying capacity of the output buffer 234 for the encoder and as new frames are stored in, and retrieved from, the output buffer so that the output buffer can meet the target bitrate requirements. The encode units 214, 216, 218 receive the QP from the BRC 226 in order to maintain a certain desired target bitrate, and the QP may change from frame to frame.

The output bitstreams 210, 220, 222, 224 respectively generated by encode units 212, 214, 216, 218 each may be any bitstream representative of video 201 such as an HEVC compliant bitstream. System 200 may generate any number Z of bitstreams having various resolutions, bitrates, frame rates, etc. such as dozens or even over 200 bitstreams. Such bitstreams may be subsequently transmitted, optionally dynamically, to decode devices for consumption by users. Bitstreams or videos 210, 220, 222, 224 as generated by encode units 212, 214, 216, 218 using encode controls to improve the bitstreams may be stored in memory such as the output buffer(s) 234, transmitted to another device, and so on for eventual decode and presentment of the decoded video to a user or users.

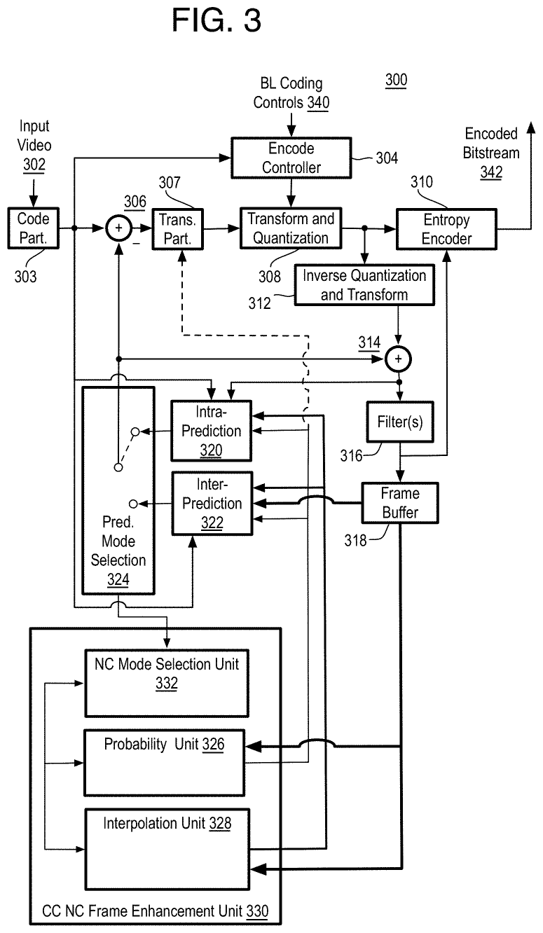

Referring to FIG. 3, an image processing system 300 may be, or have, an encoder 300 that may be any one of encoders 212, 214, 216, or 218 (FIG. 2) for example, to perform multiple channel video coding (or clustered video coding) arranged in accordance with at least some implementations of the present disclosure. As shown, encoder 300 receives input video 302 and includes a coding partition unit 303, an encoder controller 304, subtract or adder 306, transform partitioner unit 307, a transform and quantization module 308, and an entropy encoder 310. A decoding loop of the encoder 300 includes at least an inverse quantization and transform module 312, adder 314, in-loop filters 316, a frame buffer 318, an intra-prediction module 320, an inter-prediction module 322, a prediction mode selection unit 324, and cross-channel (CC) non-concurrent (NC) enhancement unit 330.

In operation, encoder 300 receives input video 302 as described above. Input video 302 may be in any suitable format and may be received via any suitable technique such as downsampling of video 201, fetching from memory, transmission from another device, etc. Encode of input video 302 may be controlled, in part, by block level coding controls 340 such that various encode decisions for input video 302 are made or influenced by block level coding controls 340 that are the encode controls described above based on cross-channel referencing. For example, block or CU sizes, transform unit split depths, motion vectors, motion search constraints, intra modes, intra search constraints and so on are implemented via encode controller 304 using block level coding controls 340.

By one example form for high efficiency video coding (HEVC), this standard uses the coding units (CUs) or large coding units (LCU). For this standard, a current frame may be partitioned for compression by the coding partitioner 303 by division into one or more slices of coding tree blocks (e.g., 64×64 luma samples with corresponding chroma samples). Each coding tree block also may be divided into the coding units (CU) in quad-tree split scheme. Further, each leaf CU on the quad-tree may either be split again to four CUs or divided into partition units (PUs) for motion-compensated prediction. In various implementations in accordance with the present disclosure, CUs may have various sizes including, but not limited to 64×64, 32×32, 16×16, and 8×8, while for a 2N×2N CU, the corresponding PUs also may have various sizes including, but not limited to, 2N×2N, 2N×N, N×2N, N×N, 2N×0.5N, 2N×1.5N, 0.5N×2N, and 2.5N×2N. By some forms, the smallest available prediction block is a 4×4 or 8×8 block, referred to herein as the base block size. Important here is that a single CU can have multiple different alternative PU block arrangements and is not limited to any single PU block arrangement. Also, it should be noted that the foregoing are only example CU partition and PU partition shapes and sizes, the present disclosure not being limited to any particular CU partition and PU partition shapes and/or sizes, and this applies similarly to other video coding standards such as a VP_standard that refers to tiles divided into superblocks that are similar in size to CUs for example.

Based at least in part on block level coding controls 340 or CC NC enhancement unit 330 control, frames of input video 302 may be processed to determine coding portions thereof (e.g., blocks, coding tree units, coding units, partitions etc.). The changes from the block level coding controls 340 are applied to the concurrent frames while the controls from the CC NC enhancement unit 330 are applied to the non-concurrent frames when one current video channel 302 is a higher frame rate video than another lower frame rate video encoded by the current encoder 300 or another encoder.

As shown, input video 302 then may be provided to encode controller 304, intra-prediction module 320, and inter-prediction module 322. The coupling to intra-prediction module 320 or inter-prediction module 322 may be made via mode selection module 324 as shown. For example, mode selection module 324 may make final mode decisions for portions of video frames of input video 302, again, based on limited evaluation, searching, etc. as indicated by block level coding controls 340 or CC NC frame enhancement unit 330 controls.

As shown, mode selection module 324 (e.g., via a switch), may select, for a coding unit or block or the like between an intra-prediction mode and an inter-prediction mode based on block level coding controls 340 or CC NC enhancement unit 330 as well as minimum coding cost as determined based on the limited search. Based on the mode selection, a predicted portion of the video frame is differenced via differencer (or adder) 306 with the original portion of the video frame to generate a residual. The residual may be transferred to a transform partitioner 307 that divides the frames into transform blocks, and then a transform and quantization module 308, which may transform (e.g., via a discrete cosine transform or the like) the residual to determine transform coefficients and quantize the transform coefficients using the frame level QP discussed herein. Such transform operations and any partial split depth evaluation may be determined under control of block level coding controls 340 or CC NC enhancement unit 330. The quantized transform coefficients may be encoded via entropy encoder 310 into encoded bitstream 342. Other data, such as motion vector residuals, modes data, transform size data, or the like also may be encoded and inserted into encoded bitstream 342.

Furthermore at the decoding loop, the quantized transform coefficients are inverse quantized and inverse transformed via inverse quantization and transform module 312 to generate a reconstructed residual. The reconstructed residual may be combined with the aforementioned predicted portion at adder 314 to form a reconstructed portion, which may be filtered using in-loop filters 316 to generate a reconstructed frame. The reconstructed frame is then saved to frame buffer 318 and used as a reference frame for encoding other portions of the current or other video frames. Such processing may be repeated for any additional frames of input video 302.

As to encoding of the non-concurrent frame, the cross-channel (CC) non-concurrent (NC) enhancement unit 330 has a probability unit 326 to handle the probabilistic method operations, an interpolation unit 328 to handle the interpolation method operations, and a NC mode selection unit 332 to determine which method is to be used. The CC NC enhancement unit 330 may adjust encoder parameters directly as shown or may provide controls to the encoder controller 304 instead in order to implement the changes. Such operations may include determining and obtaining encode control (EC) reference frames that may be different than default reference frames initially designated by the encode controller 304 according to the GOP of a current frame being reconstructed. The CC NC enhancement unit 330, or encode controller 340, then directs, or has the prediction units 320 and 322 conduct, motion detection or estimation between such EC reference frames, interpolation computations to set the prediction data of a non-concurrent frame, changing the candidate prediction modes, analyzing the interpolated prediction data of the non-concurrent frame, and so forth as described below. The operations may proceed frame by frame, and CU by CU on each frame by one example. Any other modules of the encoder are known to those of skill in the art and are not discussed further herein with respect to FIG. 3 for the sake of clarity in presentation. The details are provided below.

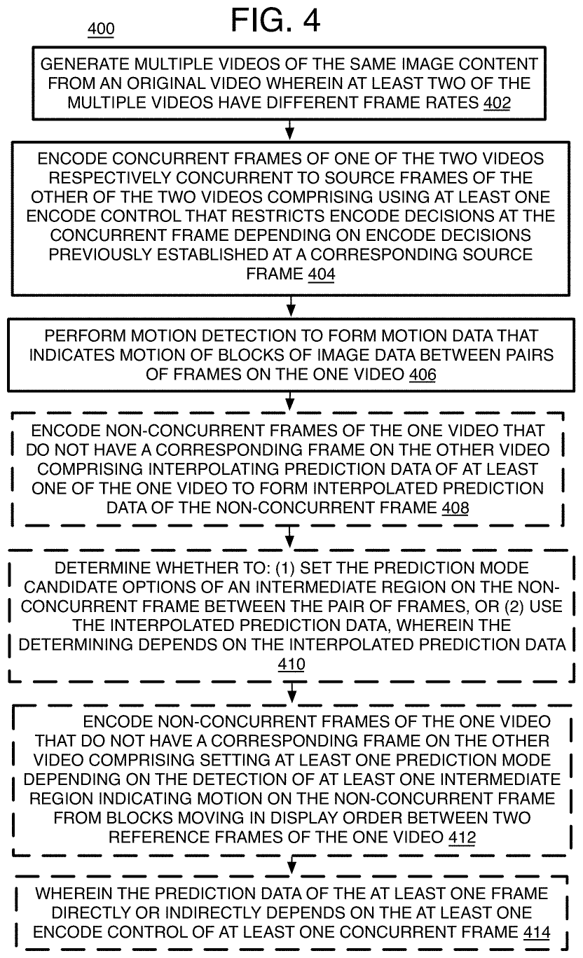

Referring to FIG. 4, an example process 400 for video coding is arranged in accordance with at least some implementations of the present disclosure. Process 400 may include one or more operations 402-412 numbered evenly. Process 400 may form at least part of a video coding process. By way of non-limiting example, process 400 may perform a coding process as performed by any device or system as discussed herein such as system or device 200, 300 and/or 1200.

Process 400 may include “generate multiple videos of the same image content from an original video wherein at least two of the multiple videos have different frame rates” 402. Thus, an original video may be received at a transcoder in compressed form for decoding first before being provided to one or more encoders, or may be provided to the encoders directly. The original video is divided or resized into multiple bitstreams (or videos) with at least one difference between the videos. The multiple videos may number from a few, such as four, to many, such as 200 for example. By one form, the videos may vary from video to video (or channel to channel) by resolution and/or bitrate, but the concern here is the variation by frame rate in at least two of the videos or video channels. This operation also may include pre-processing one or more of the videos including the original video to be in a format compatible with one or more of the encoders.

Process 400 may include “encode concurrent frames of one of the two videos respectively concurrent to source frames of the other of the two videos comprising using at least one encode control that restricts encode decisions at the concurrent frame depending on encode decisions previously established at a corresponding source frame” 404. The encode control as described above may limit which candidate prediction modes can be used for inter or intra prediction as well as other restrictions that either reduce the number of candidates being considered or may provide a specific candidate to use to eliminate a selection altogether. Specifically, once, or as, a first source video is encoded, such as a lower frame rate video, coding parameters are obtained from that first video and translated into encoding controls by the encode control unit 232 (FIG. 2). The encode controls are then provided to other sink videos by using the encode controls or block level controls 340 provided to encoder 300 (FIG. 3) for example. This reduction in the number of alternatives for encode decisions as described above increases performance without a noticeable effect to quality.

The sink or input video (302 on FIG. 3) is then encoded at a second resolution or second bitrate versus at the source video, and using the encode controls to generate a second bitstream, wherein the second bitstream is independent of a first bitstream from the source video. The first and second bitstreams are independent in that the first and second bitstreams do not rely in any way on each other for decode of the video (e.g., the actual operations performing the decoding rather than cross-referencing data to obtain encoder settings).

Process 400 may include “perform motion detection to form motion data that indicates motion of blocks of image data between pairs of frames on the one video” 406. Specifically, when the system is deciding whether to apply the probabilistic technique or the interpolation technique to a non-concurrent frame being reconstructed for encoding, the system may make the decision by analyzing motion between a reference frame (referred to as the at least one frame below) of the non-concurrent frame and a next subsequent frame after the non-concurrent frame in display order. Both of these frames are prior to the non-concurrent frame in encoding order so that their prediction data including motion data has already been determined.

The motion detection performed here may be considered an operation of the interpolation, and includes performing a block matching search between the two frames. By one form, this generates motion vectors from the first or base encode control (EC) reference frame to the other or subsequent EC reference frame to track the motion.

Process 400 may include “encode non-concurrent frames of the one video that do not have a corresponding frame on the other video comprising interpolating prediction data of at least one frame of the one video to form interpolated prediction data of the non-concurrent frame,” 408. Here, the system now interpolates the motion data to form candidate prediction data for the non-concurrent frame. By one form, the motion vectors of one of the EC reference frames are reduced in proportion formed by the two frame rates of source and sink videos being encoded. For example, when encode controls are being provided from a 30 fps video to a 60 fps video, then the motion vectors are halved (30/60) to indicate motion from the EC reference frame to the non-concurrent frame, thereby establishing the interpolated prediction data. Other factors may be considered to increase the accuracy and performance such as treatment of intra blocks and detected flat regions as described below.

By one alternative approach then, process 400 may include “determine whether to: (1) set the prediction mode candidate options of an intermediate motion region on the non-concurrent frame between the pair of reference frames, or (2) use the interpolated prediction data, wherein the determining depends on the interpolated prediction data” 410. This operation involves analyzing the interpolated prediction data of the non-concurrent frame. When blocks on the non-concurrent frame are found to have no inbound motion vectors (whether or not outbound motion vectors exist for the blocks) and the blocks are not intra blocks, then these blocks are undersampled. Undersampled blocks, which indicate less complex image content, are reserved for the probabilistic technique, while those that are not undersampled, and therefore include more complex images, use the interpolation technique that was already applied to make this non-concurrent prediction encoding technique decision. Generally, when one or more blocks are not undersampled, the system uses the already generated interpolated prediction data in the form of the interpolated motion vectors as the non-concurrent prediction data of the blocks.

It should be noted that this decision may be performed block by block on the reference frame or non-concurrent frame. By another form, however, the decision may be applied on a frame by frame basis such that interpolation is used on the blocks in the non-concurrent frame unless a minimum threshold number of undersampled blocks are found on the single non-concurrent frame. In this latter case, the probabilistic technique is used for all blocks on the non-concurrent frame when a sufficient number of the blocks on the non-concurrent frame are undersampled. Such frame level decision will increase efficiency.

When the probabilistic technique is being used, process 400 may include “encode non-concurrent frames of the one video that do not have a corresponding frame on the other video comprising setting at least one prediction mode depending on the detection of at least one intermediate region indicating motion on the non-concurrent frame from blocks moving in display order between two reference frames of the one video” 412. In this case, the system or method determines which blocks moved between the two EC reference frames (the reference frame and the subsequent frame in display order), and sets intermediate motion regions in CUs on the non-concurrent frame where the non-concurrent frame intersects the motion of those blocks. These regions then indicate blocks in motion between the two EC reference frames.

Once an intermediate region is determined, the prediction modes can be set, which may include adjusting or modifying the prediction modes from the default that would have been used without the encode control enhancement. In this case, and due to the high likelihood of motion in the intermediate regions, the prediction modes may be set by expanding the available block sizes of prediction mode candidates to block sizes at and between the block sizes of the coding units of the blocks being tracked between the two EC reference frames. Otherwise, transform block sizes may be changed similarly, a full block search may be performed, and intra-prediction modes may be added as well.

Process 400 may include “wherein the prediction data of the at least one frame directly or indirectly depends on the at least one encode control of at least one concurrent frame” 414. In other words, the EC reference frames provide the influence of the encode controls whether these frames are concurrent frames or non-concurrent frames or one of each. Particularly, any concurrent frame encoded prior to a current non-concurrent frame being reconstructed and in encoding order has had encode controls used by the encoder directly to determine the prediction data of the concurrent frame. In addition, any prior non-concurrent frame also has been influenced by the encode controls because any such non-concurrent frame would have been reconstructed using a concurrent frame formed by the encode control influence or from other prior non-concurrent frames similarly reconstructed by using concurrent frames using encode controls. Thus, the use of the reference frame and subsequent frame, whether these are concurrent or non-concurrent frames, have prediction data that depends directly or indirectly from one or more encode controls.

Process 400 may be repeated any number of times either in series or in parallel for any number of videos, pieces of video content, video segments, or the like. As discussed, process 400 may provide for multi-channel video (or video cluster) encoding one piece of video content to generate multiple independent bitstreams that represent encodes of differing characteristics such as frame resolutions, bitrates, frame rates, and combinations thereof.

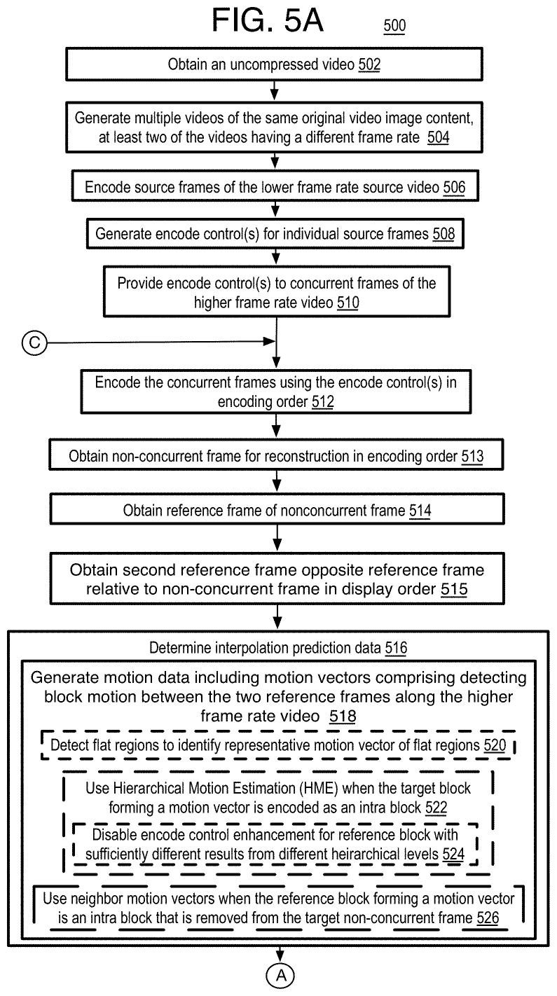

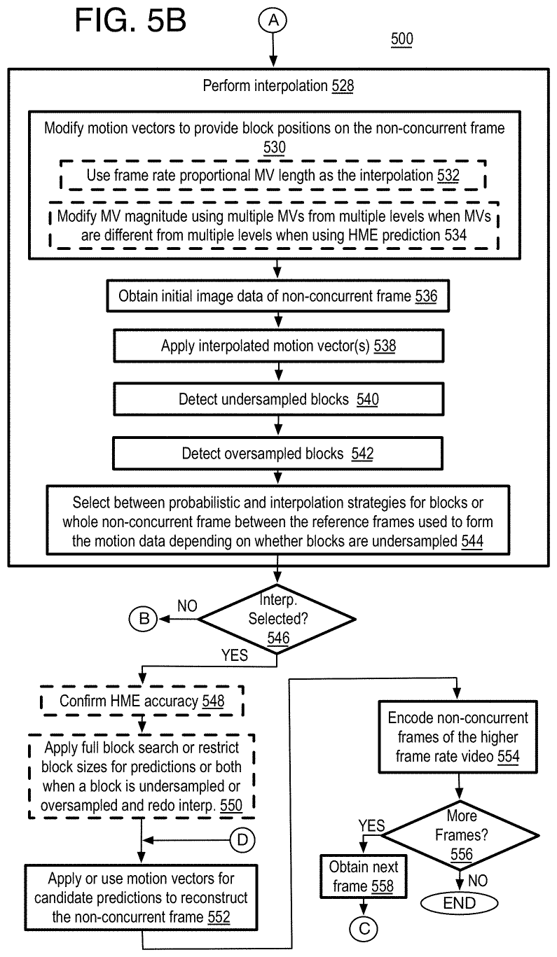

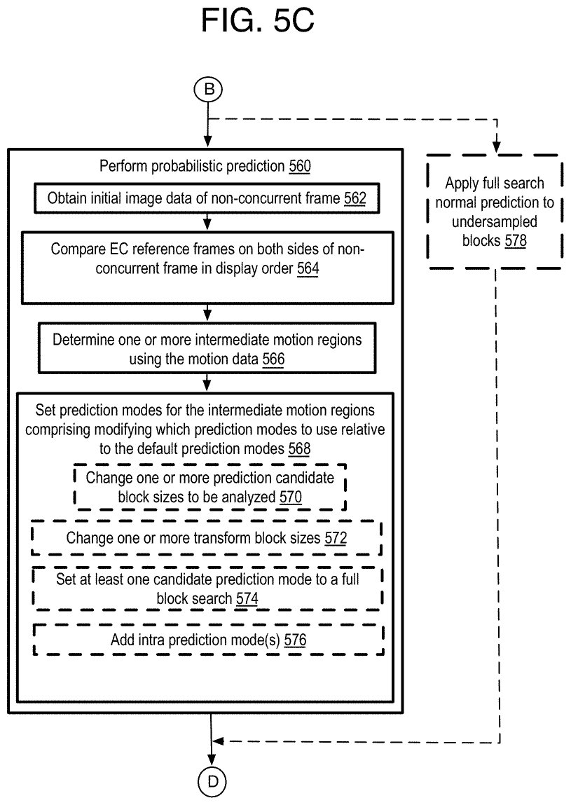

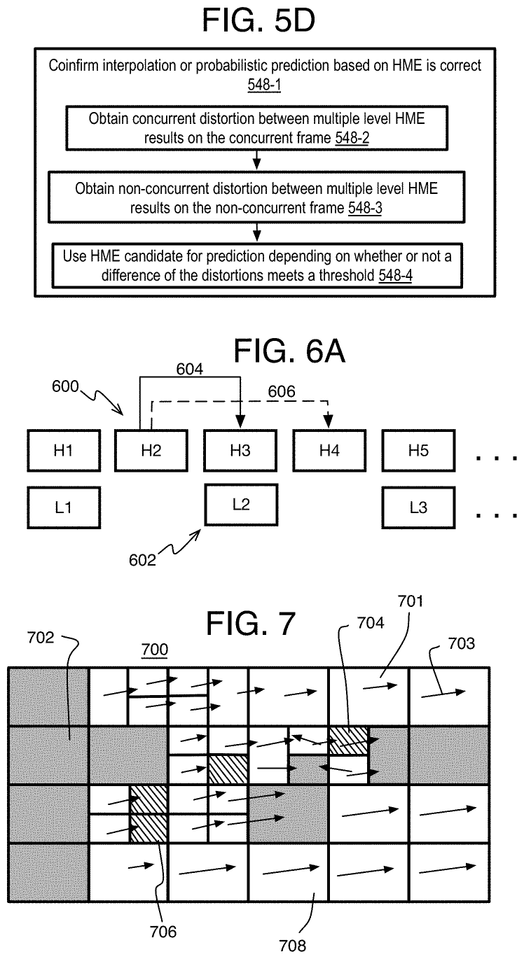

Referring to FIGS. 5A-5B, an example process 500 for video coding is arranged in accordance with at least some implementations of the present disclosure. Process 500 may include one or more operations 502-578 generally numbered evenly. Process 500 may form at least part of a video coding process. By way of non-limiting example, process 500 may perform a coding process as performed by any device or system as discussed herein such as system 100, 200 and/or video processor system or device 1200 (FIGS. 1, 2, and 12 respectively), and may be described by referring to those systems.

Process 500 may include “obtain an uncompressed video” 502, and as mentioned above, may be obtained after decoding at a transcoding server for example, or may be for encoding of stored or received raw or streaming video on any computing device with coder capabilities as mentioned herein, such as a smart phone, tablet, digital camera, or other computing device. The video may include luminance and chroma data pre-processed sufficiently for encoding, but is otherwise as described above with systems 200 or 300 and process 400.

Process 500 may include “generate multiple videos of the same original video image content, at least two of the videos having a different frame rate” 504. This may involve generating multiple videos in separate channels and each formed of video frames. This may involve resizing or downsampling, where by one example form, the uncompressed video may be provided in a 4K resolution video, and video sequences of 1080p, 780p, and 480p may be formed by downsizing the 4K video. This also may involve encoding each of the different resolution video sequences at different bitrates and at least different frame rates. The videos or channels of different frame rates are treated as described below.

Process 500 may include “encode source frames of the lower frame rate source video” 506, and the source video is encoded as mentioned above by known coding standards such as HEVC, and so forth. The result is compressed image data of the source video as well as the coding parameters used to encode the source video. The coding parameters may include block and other partition size and placement selections for a number of different encoding stages such as prediction and transform as well as encoder control unit size, inter-prediction selections, intra-prediction selections, prediction mode alternatives, and so forth as mentioned above.

Process 500 may include “generate encode control(s) for individual source frames” 508. The coding parameters are then translated into encode controls that can be used by the sink videos or channels. The details of such translating is provided by U.S. patent application Ser. Nos. 16/369,937 and 16/582,975 cited above. By one example, the block based coding parameters are translated to block based encode controls for encode of the video at a second frame rate, second resolution, and/or a second bitrate such that the encode controls include restrictions to encode decisions at a block level. The encode controls may be any controls discussed herein such as restrictions to check only inter modes and eliminate checks of intra modes for one or more blocks, restrictions to check only intra modes and eliminate checks of inter modes for one or more blocks, restriction to check only a limited size of coding units for one or more blocks, a restriction to check only a limited size of transform units for one or more blocks, or any other restrictions or controls discussed herein. In an implementation, translating includes scaling motion vectors. In an implementation, translating coding parameters to encode controls includes setting, when a prediction mode decision for a number of overlapping blocks is an intra mode, a restriction for the first block to only check intra modes or setting, when the prediction mode decisions for overlapping blocks are a mix of intra and inter modes, no mode check restriction for the first block. In some implementations, translating considers coding unit or block sizes at the source sequence frame to limit a coding unit partition size check. In an implementation, translating considers whether the source has a zero or non-zero transform unit split depth to limit block based coding parameters to either a zero or non-zero transform split depth of blocks on the source sequence frame or limit a transform unit split depth check. In some implementations, translating limits motion estimation searches to near motion vector locations from the source sequence. In an implementation, translating may consider whether the source or sink frame is a reference frame or a non-reference frame for inter prediction.

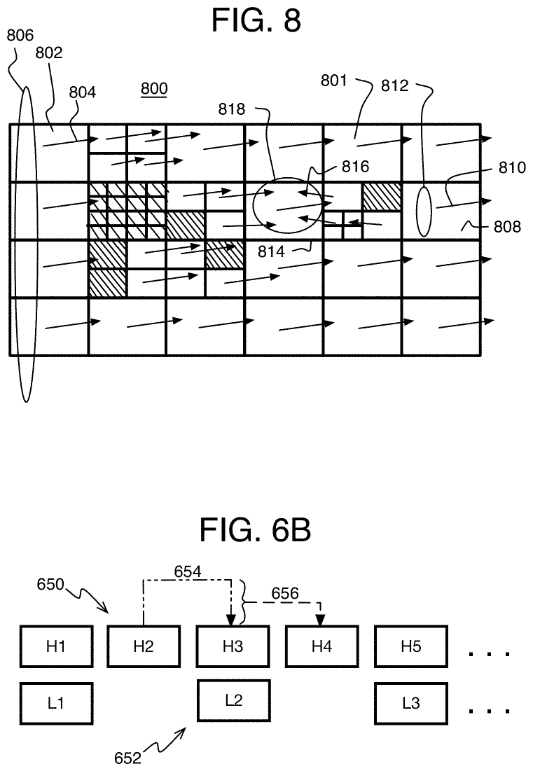

Referring to FIG. 6A, process 500 may include “provide encode control(s) to concurrent frame of the higher frame rate video” 510. An example higher frame rate (sink) video 600, such as 60 fps, is shown with concurrent frames H1, H3, and H5 corresponding in time to source frames L1, L3, and L5 on a lower frame rate video 602, at 30 fps for example. For this operation, the encoding parameters of the source frames L1, L3, and L5 are translated into encode controls. The encode controls are then respectively provided to the concurrent frames H1, H3, and H5 as the controls 340 (FIG. 3) for example.

Process 500 next may include “encode the concurrent frames using the encode control(s) in encoding order” 512, and as described above, by using the encode controls to set or limit prediction modes or other parameter settings for the encoder thereby taking advantage of parameter decisions already made on the source frames, resulting in increased performance. Thus, this operation at least reduces the number of alternatives for certain encoder decisions (such as whether to check intra options for prediction) and/or reduces a matching search space such as for inter-prediction motion estimation searches on reference frames. The encoder control could also may set a specific alternative choice and eliminate the decision making altogether. The details for such application of encode controls also is provide by the U.S. patent application Ser. Nos. 16/369,937 and 16/582,975 cited above.

Process 500 may include “obtain non-concurrent frame for reconstruction in encoding order” 513, and specifically the non-concurrent frames as obtained in encoding order along the video sequence being encoded such as frame H4 in the higher frame rate video 600 (FIG. 6A). Thus, the non-concurrent frames are obtained alternately with the concurrent frames in the encoding order. This may include obtaining original or synthesized frames that are input to the encoder, and providing the original input data, so that the encoder can form predictions when needed and/or add or difference residuals from the original data as explained above with encoder 300 (FIG. 3). This also may include whatever pre-processing needs to be performed to the image data of the non-concurrent frame so that the non-concurrent frame is in a sufficient format for encoding if not already performed as mentioned above.

Process 500 may include “obtain reference frame of non-concurrent frame” 514. Here, the immediately prior frame relative to a current non-concurrent frame being reconstructed is obtained as a reference frame for the current non-concurrent frame, and in display order. The reference frame may be referred to as encode control (EC) reference frame. This EC reference frame also is prior to the current non-concurrent frame so that the EC reference frame already has its selected prediction data that was, or will be, used for encoding that EC reference frame. In many cases, but not necessarily all cases, the EC reference frame here will be the same reference frame designated as a reference frame type for the current non-concurrent frame in a group of picture (GOP) structure. Thus, when the current non-concurrent frame is H4 and is a B-frame, then H2 may be the P-frame EC reference frame shown in encoding order on video 600. For differentiation the prior EC reference frame in display order also may be referred to as the first or base EC reference frame.

Process 500 may include “obtain second reference frame opposite reference frame relative to non-concurrent frame in display order” 515. Here, a frame that comes immediately after the current no-concurrent frame in display order, but still prior to the non-concurrent frame in encoding order, may be used as a second EC reference frame of the current non-concurrent frame H4, such as H3 on video 600 for example. This frame also may or may not be designated a reference frame in a GOP.

It should be noted that the encode control non-concurrent frame encoding is not limited by the encoder or standard GOPs as long as two prior EC reference frames are already encoded in encoding order and are adjacent book-end frames to the non-concurrent frame being reconstructed and in display order. Thus, for example, one encoding order that is common is IPBBB in encoding order, which is IBBBP in display order and as numbered 0 to 4 in display order. The sequence is then 0, 4, 1, 2, 3 in encoding order. Say the non-concurrent frames are the odd frames in encoding order frames 4 and 2. The prior encoded EC reference frames are frames 1 and 4 for example. In this example, then the two EC references are not necessarily both adjacent the non-concurrent frame in display order. By one approach, only one of them needs to be adjacent or next to the non-concurrent frame, but otherwise, both EC reference frames should be as close as possible.

As another example for a more complex GOP, some GOPs use depth levels where a depth level provides different reference frame relationships and priority in a video sequence. The lower the depth, the greater the importance of the frame for the video sequence. Thus, by one example, a GOP of IBBBPBBBP in display order is numbered in this order from 0 to 8. This GOP may have an encoding order of 0, 8, 4, 2, 6, 1, 3, 5, 7. Frames 0 and 8 are on level 0, and frame 4, the middle P frame, is on level 1. The B frames 2 and 6 that can used as reference frames are on level 2, and the remaining odd B-frames 1, 3, 5, 7 are on level 3. If the odd frames in encoding order are the non-concurrent frames (frames 8, 2, 1, and 5), then this is a simple case where the two adjacent EC references for most of these non-concurrent frames already have their prediction data in encoding order. So frame 2 uses frames 0 and 4 as EC references, frame 1 can use frames 0 and 2 as EC reference frames, and frame 5 uses frames 4 and 6 as EC reference frames, and so forth. It will be noted from this that the EC reference frames need only be prior in encoding order and need not be immediately prior in encoding order as long as the frames are the two adjacent before and after, or book end, frames in display order.

Continuing with the example of the complex GOP with frames 0 to 8, and the initial frame, usually an I-frame, should always be a concurrent frame. When starting a sequence, the frames 0 of both low and high frame rate videos are the same frame. An I-frame should always use an I-frame for encode control referencing, and are usually aligned with each other. When the first P-frame in a GOP (frame 8) is a non-concurrent frame as here, the EC reference frame may only use the single frame 0 as the EC reference frame in this case. Otherwise, when a B-frame or later P-frame is the non-concurrent frame, but the adjacent frames (in display order) are not already encoded in encoding order, then the EC reference frames for those non-concurrent frames may be already encoded (or having prediction data) EC reference frames, one on each side (prior and subsequent) to the non-concurrent frame, and frames that are as close as possible to the non-concurrent frame within the sequence.

Process 500 may include “determine interpolation prediction data” 516, and as mentioned, by one alternative, interpolation may be performed first to determine the motion pattern complexity on the non-concurrent image, and in turn, to determine whether interpolation strategy or the probabilistic strategy should be used. This may first include “generate motion data including motion vectors comprising detecting block motion between the two reference frames along the higher frame rate video” 518. This may involve determining block motion from one of the EC reference frames to the other EC reference frame. This may be accomplished by the use of one or more of many different inter-prediction techniques including full integer or fractional searches. By one form, the encoder may use global motion models such as hierarchical motion estimation (HME), or other such motion estimation techniques, where the technique stores motion vectors for every inter block on the frame. The result is motion vectors from EC reference to EC reference which can then be modified as discussed below.

It should be noted, however, that performing a simple motion vector search between EC references to set the motion vectors for the non-concurrent frame may not be adequate, in itself, in certain circumstances or may be too inefficient. The following addresses such concerns.

By one form, process 500 may include “detect flat regions to identify representative motion vector of flat regions” 520. Specifically, flat regions with the same image data over multiple blocks may share the same motion vector (length and direction). This avoids duplication of effort substantially reducing computational loads, bit cost, and time consumption. By one form, an integer motion estimation (IME) may be used to detect for large flat regions. In this case, consistent distortions for many pixels checked in a region indicates a flat region. Any motion vector in that region would be sufficient. So on those IME checks, a limited range in distortion (or MV) values over a region on a frame that remains lower than a distortion threshold indicate a flat region. Such a motion vector may be saved in a merge list and used by all blocks in the flat region.

HME may be used to detect the flat region as well. Spatial distortion from hierarchical motion can be analyzed since a very low distortion between hierarchy levels over a region that remains lower than a distortion threshold is indicative of a flat or consistent region.

Finally, merge list motion vectors detected by using normal encoder motion estimation with GOP references, rather than only using the EC references, also may be used as the region motion vector but will not be as accurate as when using the EC references.

Another complication is when an inter block on the EC reference frame points to an intra block on the other EC reference frame, and in turn, on the non-concurrent frame between them. When the encoder uses other default motion estimation techniques on the current non-concurrent frame being reconstructed, then process 500 may include “use hierarchical motion estimation (HME) when the target block forming a motion vector is encoded as an intra block” 522. The different levels then can be compared and the distortion between the levels analyzed to form the prediction data of the block on the non-concurrent frame. Thus, the inter block motion vector of the best candidate that points to an intra block on the non-concurrent frame (the inter block was “lost”) can still be used.

Process 500, however, next may include “disable encode control enhancement for reference block with sufficiently different results from different hierarchical levels” 524. This may occur because the blocks may be interpolated from different levels, and a motion predicted CU might have one block on one level indicating one encode control enhancement and the same block on another level may indicate a different encode control enhancement resulting in relatively large image data differences between the two levels. In this case, when the level to level distortion is too large relative to a threshold, and the target block at the non-concurrent frame is an intra block, then the prediction data will be erroneous.

By another approach, instead of disabling the encode control enhancement, the intra block on the non-concurrent frame simply may be analyzed with the usual intra-prediction modes instead.

Referring to FIG. 7, a non-concurrent image 700 is divided into CUs 701. The CUs may be further divided into sub-blocks (or smaller blocks CUs or PUs). The blocks are shown with a number of different example block treatments as described herein with motion vector arrows 703 of some of the blocks. Relevant here, the blocks 704 and 706 with diagonal hash shows intra blocks that were inter blocks on the prior first EC reference frame, and as indicated by the motion vector arrows pointed toward those blocks. These may be treated by using HME as described above. The empty blocks 708 are inter prediction blocks, and the gray blocks 702 are full search blocks, which are described below.

Process 500 may include “use neighbor motion vectors when the reference block forming a motion vector is an intra block that is removed from the target non-concurrent frame” 526. This operation involves the opposite intra situation as that described above. Here, the EC reference block is an intra block but results in an inter block on the non-concurrent frame. This may be due to global motion, especially at edges of an image for example. In this case, the motion vectors of the neighbor or adjacent block to an intra block on the EC reference frame may be used as the motion vector for the intra block.

Once the motion vectors are set, process 500 may include “perform interpolation” 528, and specifically, “modify motion vectors to provide block positions on the non-concurrent frame” 530. By one form, process 500 may include “use frame rate proportional MV length as the interpolation” 532. This operation then may involve revising the motion vectors extending from a base or first EC reference frame of the two EC reference frame to the other EC reference frame. The default base or first EC reference frame may be the EC reference frame that is before the non-concurrent frame in display order by one example. The prediction data, or the magnitude (or length) of the motion vectors, of the base EC reference frame may be changed depending on the proportion of frame rates of the source video frame rate over the sink video frame rate. For 30 fps to 60 fps (30/60), the MV is halved to form the interpolated motion vectors, and in turn, matching block locations on the non-concurrent frame and relative to blocks on the base EC reference frame. In other words, the encoder extrapolates the mid-point from inter-prediction motion vectors and adjusts the relevant block positions on the non-concurrent frame accordingly. At this point, this may be considered interpolation from a single reference frame since both EC reference frames are not needed in the computation to modify the motion vectors, although the second reference frame was initially needed to form the motion vectors in the first place. The interpolated motion vectors, and resulting block location and image data described below, is the generated interpolated prediction data of the non-concurrent block.

Referring again to FIG. 6A, the interpolation is represented by motion vector 604 from the first or base EF reference H2 to the second EF reference H3, and then a motion vector 606 (shown in dashed line) represents the modified motion vector from the first EF reference H2 to the current non-concurrent frame H4 being reconstructed.

Process 500 may include “modify MV magnitude using multiple MVs from multiple levels when MVs are different from multiple levels when using HME prediction” 534. Thus, when using HME as described above, and multiple levels each have a different motion vector, then the MVs may be modified including combining them or using a representative one of the motion vectors for the same single block being analyzed. Thus, a mean or median motion vector of the levels may be used, or some other combination or single motion vector such as smallest or greatest motion vector may be used. Many variations are contemplated.

Thereafter, process 500 may include “obtain initial image data of non-concurrent frame” 536, and the original data already mentioned above so that the block locations on the frames can be modified by adding residuals as described below.

Thus, process 500 then may include “apply interpolated motion vector(s)” 538, and to form the image data of the blocks and shift block locations according to the interpolated prediction data (the modified motion vectors). This is performed for each block on the non-concurrent frame. This also may include alternative candidate motion vectors for the same block when multiple candidates are still being provided, such as with HME when differences in multiple levels is to be maintained for prediction selection.

Referring to FIG. 8, process 500 may include “detect undersampled blocks” 540. Specifically, one way to determine the complexity of the image data on the non-concurrent frame is to determine whether blocks on the frame are undersampled. This includes determining which inter blocks on the non-concurrent frame do not have or receive an incoming motion vector. For example, a non-concurrent frame 800 is divided into CUs or blocks 801 where a column of blocks 802 has no incoming motion vectors as indicated at 806. Similarly, a block 808 has an outgoing motion vector 810 but no incoming motion vectors such that it has an area 812 that is undersampled. These blocks are considered undersampled and in this example, are used to determine which EC strategy to use, and also may be used to modify which prediction modes to use as described below. In this case, there is insufficient prediction data to accurately enhance the image data of the non-concurrent frame at these CUs.

Referring again to FIG. 8, process 500 may include “detect oversampled blocks” 542, where blocks such as block 814 on frame 800 has more than one motion vector 816 incoming or received by the block 814, and therefore has, or is, an oversampled area 818. Too many motion vectors describes a complex image area that cannot be enhanced directly with such conflicting data. This also is handled below.

Process 500 may include “select between probabilistic and interpolation strategies for blocks or whole non-concurrent frame between the reference frames used to form the motion data depending on whether blocks are undersampled” 544. The undersampled blocks reveal a lack of complexity of the image data in the block. When a block is undersampled, the probabilistic strategy will be used, and the interpolation data is dropped. This is tested block by block when using a block based test. In the alternative, a frame based test may be used so that when a certain threshold number of undersampled blocks in the non-concurrent frame are found, then all blocks are encoded using the probabilistic strategy rather than the interpolation strategy, and the interpolation data is dropped. This still can raise the efficiency of the process over a number of frames and compared to omitting the enhancement completely. By another alternative, the decision may be based on a threshold change in motion vector field from HME results as well. Yet for another option described below, a full normal search may be applied instead of the probabilistic strategy for undersampled blocks.

Process 500 may include the inquiry “interpolation selected?” 546, and if a block on the non-concurrent frame is sufficiently complex and interpolation is to be applied, then process 500 also may include “confirm HME accuracy” 548, or in other words, “confirm interpolation or probabilistic prediction based on HME is correct” 548-1 (FIG. 5D). Specifically, when HME is used as the search technique to form interpolated motion vectors, the encoder can use the HME results as a quality check, where the initial distortion from a first mode check can be used to compare to the prior blocks to see how closely it matches, thereby dynamically optimizing the limited CU size check as the distortion gives an indication of the motion being correct.

In particular, operation 548 may include “obtain concurrent distortion between multiple level HME results on the concurrent frame” 548-2. This may involve obtaining differences of motion vectors between each two levels of the HME. The motion vectors are those of the prior EC reference frame being used for the current non-concurrent frame.

Operation 548 next may include “obtain non-concurrent distortion between multiple level HME results on the non-concurrent frame” 548-3, and this refers to finding the differences in motion vector from level to level again, except here for the motion vectors generated by interpolation for the non-concurrent frame. These differences are obtained for the same levels as that used on the EC reference frame.

Operation 548 may include “use HME candidate for prediction depending on whether or not a difference of the distortions meets a threshold” 548-4. Now, the differences of the motion vectors of the same levels are compared between the EC reference frame and the current non-concurrent frame. If the difference, or distortion, from frame to frame is below a threshold, then the motion prediction is accurate and the HME results can be used. If the differences are over the threshold, then the HME results should not be used. This test may be applied to both the interpolation and probabilistic strategies (although not shown that way), or results of any of the other searches applied herein, including modified prediction modes of undersampled or oversampled blocks described next.

Continuing with process 500 and returning to operation 550, process 500 may include “apply full block search or restrict block sizes for predictions or both when a block is undersampled or oversampled and redo interpolation” 550. In this case, a full search may be applied to an undersampled block using interpolation where all possible block locations and configurations for a CU are checked. This may include checking all possible available block locations in a CU (or frame). This may be set to a certain block size for each search or may vary alternative block sizes. Such full search blocks 702 are shown on frame 700 (FIG. 7). By other alternatives, the prediction neighbor blocks next to the undersampled block may be used as most likely a good prediction candidate as well. Intra modes also should be checked. Also, as to block sizes, the candidate block sizes checked should be expanded so that if a neighbor block uses 16×16 inter blocks, then block sizes close to that (above and below such as 32×32 to 8×8) should be checked as well.

The same considerations may be applied to interpolation of the oversampled blocks. The undersampled and oversampled blocks also may have defaults as tie breakers such as a bias toward a smaller block being checked for instance. Once the prediction mode is modified here due to the under or oversampling, the interpolation is redone and new prediction data is obtained for the encoding.

Process 500 may include “apply or use motion vectors for candidate predictions to reconstruct the non-concurrent frame” 552, and here the selected candidate or candidates are used in motion compensation and prediction mode selection to make a final determination. The encoder may omit selecting a prediction mode in favor of a predetermined preferred prediction mode if so presented by the encode controls, or all possible candidates of the enhancement alone, or together with normal candidates, still may be considered.

Process 500 may include “encode non-concurrent frames of the higher frame rate video” 554, and this may include completing the encoding by applying a residual resulting from the prediction to the original image data, performing transform and quantization, and entropy coding the resulting data for transmission. The compressed frames then may be packed into bitstreams and stored or transmitted. Notably, the bitstreams may be transmitted, stored, etc. for eventual decoding by a decoder.

Next, process 500 may include the inquiry “more frames?” 556, to check if the end of the video has been reached. If so, the process ends. If not, process 500 obtains the next frame 558, and loops to operation 512 to process the next non-concurrent frame in the video.

Referring to FIG. 6B, and returning to operation 546, when a block, or the frame, is found to be less complex, process 500 may include “perform probabilistic prediction” 560. A high frame rate video 650 has concurrent frames H1, H3, and H5 concurrent to source frames L1, L2, and L3 respectively of a low frame rate video 652. Non-concurrent frames H2 and H4 alternate with the concurrent frames. Here, non-concurrent frame H4 is being reconstructed, frame H2 is the base or first EC reference frame and frame H3 is the second EC reference frame. Generally, the EC reference frames H2 and H3 are compared to determine motion regions on the non-concurrent frame that indicate block motion from frame to frame simply by determining which regions of the same pixel locations are now different due to changing block sizes. This comparison is represented by arrow 654 and is not a motion vector search. Then, the motion regions are given special treatment such as changing the prediction modes for those regions, represented by arrow 656. The details of the probabilistic strategy are as follows.

This first may involve “obtain initial image data of non-concurrent frame” 562, as already described above with the interpolation strategy.

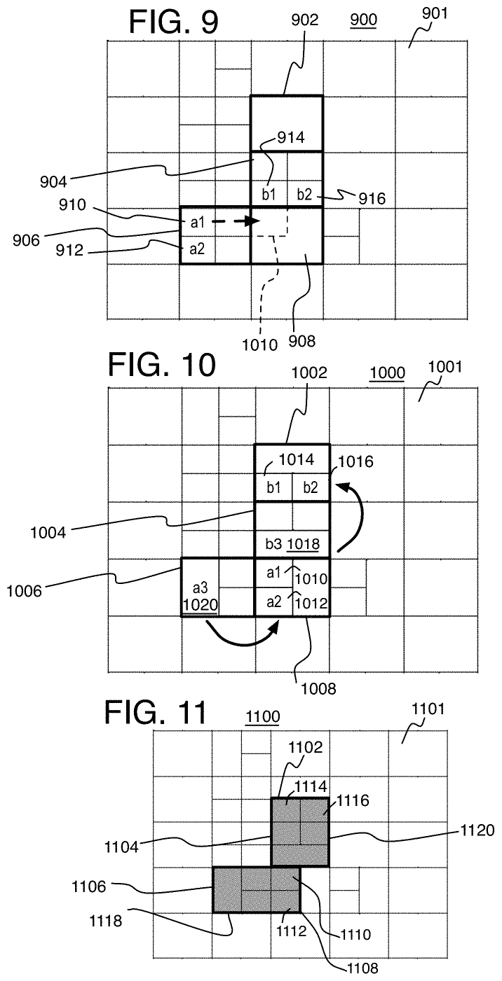

Referring to FIGS. 9-11, process 500 may include “compare EC reference frames on both sides of non-concurrent frame in display order” 564, and this refers to obtaining the same two prior EC reference frames as already used for the interpolation. A first or base EC reference frame 900 (FIG. 9) or frame N−2 may be compared to a second EF reference frame 1000 (FIG. 10) or frame N for a current non-concurrent frame 1100 (FIG. 11) or frame N−1 being reconstructed, where N−2, N−1, and N refer to display order. The frames 900, 1000, and 1100 are shown divided into rows and columns of CUs 901, 1001, 1101 respectively.

As shown while most of the blocks on EC reference frames 900 and 1000 are the same, changes occur from CUs 902, 904, 906, and 908 to CUs 1002, 1004, 1006, and 1008 respectively. Non-concurrent frame 1100 also has CUs 1102, 1104, 1106, and 1108 that correspond to the similar CU locations of frames 900 and 1000. In more detail, small blocks a1 and a2 at locations 910 and 912 in CU 906 on frame 900 move to location 1010 and 1012 respectively in CU 1008 on EC reference frame 1000. This motion forms a new larger block a3 at location 1020 that combines locations 910 and 912. Similarly small blocks b1 and b2 at locations 914 and 916 of CU 904 on EC reference frame 900 move to locations 1014 and 1016 in CU 1002. The motion forms a larger block b3 1018 combining locations 914 and 916.

The block motion from location to location is simply observed by first looking at changes in block sizes from frame to frame and due to merging or division of blocks for example, and then checking the CU sizes in the neighbors around the changing blocks. So for example, detecting blocks becoming larger such as 16×16 to 32×32 or smaller such as 32×32 to 16×16.

With this knowledge of the block motion, process 500 then may include “determine one or more intermediate motion regions using the motion data” 566. Thus, the encompassed motion of blocks a1 and a2 to locations 1112 and 1110 (matching or in the direction of the locations on frame 1000) involves CU 1006 and part of CU 1008 forming a motion region 1118 shown on the non-concurrent frame 1100. By one form, the motion region 1118 includes the start and stop block motion locations and the area between, but no more than that, and at the specific block sizes being moved. Otherwise, the entire CU may be included in the motion region whenever a CU is affected. Other arrangements for setting the size and shape of the motion region may be used as well such as including all of the smaller blocks in a coding tree unit (CTU) such as a (64×64 CTU block) or all neighbor CTUs or CUs above/below and right/left a current CU or CTU with motion.

Likewise, the motion of small blocks b1 and b2 to locations 1114 and 1116 (matching or in the direction of the locations on frame 1000) encompasses CU 1004 and part of CU 1002 to form motion region 1120 on non-concurrent frame 1100. These two regions 1118 and 1120 with known motion can then have prediction modes selected specifically for the motion and that enhance the process by improving quality and performance.

Thus, process 500 may include “set prediction modes for the intermediate motion regions comprising modifying which prediction modes to use relative to the default prediction modes” 568. For many of the blocks in low complexity frames, the CU size should not change from frame to frame, as shown on frames 900 and 1000, so that the encoder can use the matching CU size between the two EC reference frames. These are given a high probability of maintaining their CU size. The blocks that move are given lower probabilities in non-concurrent frame N-1 (1100) to know if they match EC reference frame N-2 or EC reference frame N. The prediction accuracy may be increased for these blocks by using the following prediction modes.

Process 500 may include “change one or more prediction candidate block sizes to be analyzed” 570, and this may include expanding the blocks size candidates. By one form, when the block sizes are different from EC reference to EC reference, this operation includes checking all available block sizes at and between the blocks sizes of the two EC references in the motion regions. For example, the lower probability blocks in the motion region 1118 (shaded) will check a wider range of block sizes compared to the other blocks not shaded. Also, the range of blocks impacted within the motion region can depend on a common motion vector distance, or in other words, very close to the same motion vector distance of multiple blocks, to give a wider range of pixels to be checked for high motion.

Process 500 may include “change one or more transform block sizes” 572, and this may include matching the transform block sizes to the prediction block sizes being used.

Process 500 may include “set at least one candidate prediction mode to a full block search” 574, and as already described above to check all possible available block locations in the motion region. This may be set to a certain block size for each search or may vary alternative block sizes.

Process 500 may include “add intra prediction modes” 576, and this may include any enabling a check of intra modes or checking specific intra modes such as those similar in direction to the horizontal angle for example.

Alternatively to the probabilistic strategy, process 500 may include “apply full search normal prediction to undersampled blocks” 578, and as mentioned with operation 550 above. This may be performed on any undersampled block or on the entire frame instead when desired. The process then loops back to operation 552 to complete the encoding of the current non-concurrent frame and obtain the next frame to be processed.

While implementation of the example processes 400 and 500 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

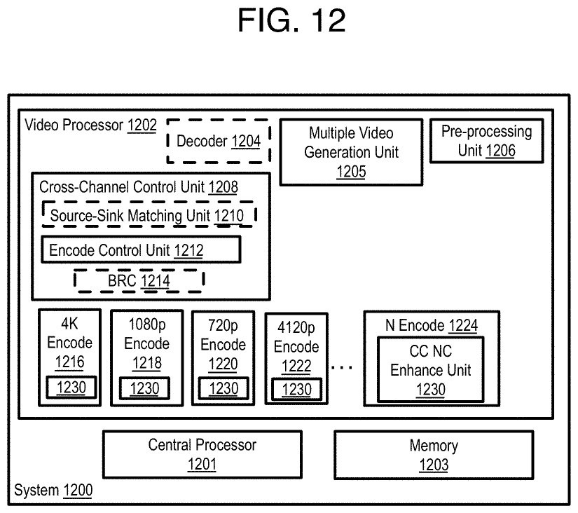

FIG. 12 is an illustrative diagram of an example system or device 1200 for video coding, arranged in accordance with at least some implementations of the present disclosure. As shown in FIG. 12, system 1200 may include a central processor 1201, a video processor 1202, and a memory 1203. The video processor 1202 optionally may have a decoder 1204 as well as a multiple sequence generation unit 1205, a pre-processing unit 1206, and a cross-channel control unit 1208. The cross-channel control unit 1208 optionally may have a source-sink matching unit 1210, an encode control unit 1212, and an optional bitrate control (BRC) 1214 similar to those units so named on system 200. The video processor 1202 also may have separate encoder modules (or encode units) 1216, 1218, 1220, 1222, to 1224 for N different encodes here shown as encodes at different resolutions 4K, 1080p, 720p, 480p, to N respectively, but also may have different frame rates as well. Each encoder 1216, 1218, 1220, 1222, to 1224 may have its own CC NC enhancement unit 1230 (or they may share one or more such units) the details and operation of which are described above.

In an implementation, memory 1203 implements buffers 202 and 234 (FIG. 2). Furthermore, in the example of system 1200, memory 1203 may store video data or related content such as frame data, frame rate data, non-concurrent frame enhancement data, bitrate-related data including QPs, any other cross-channel referencing data and encode unit data such as coding unit data, motion vector data, intra-prediction mode data, inter-prediction data, prediction mode selection data, coding unit partitioning data, transform unit split depth data, bitstream data, coding parameters, coding controls, and/or any other data as discussed herein.

As shown, in some implementations, cross-channel control unit 1208 and simultaneous encode units 1216, 1218, 1220, 1222, to 1224 are implemented via video processor 1202. In other implementations, one or more or portions of these units are implemented via central processor 1201 or another processing unit such as an image processor, a graphics processor, or the like.

Video processor 1202 may include any number and type of video, image, or graphics processing units that may provide the operations as discussed herein. Such operations may be implemented via software or hardware or a combination thereof. For example, video processor 1202 may include circuitry dedicated to manipulating frames, frame data, or the like obtained from memory 1203, and may include software and/or hardware to operate the CC NC enhancement unit 1230. Central processor 1201 may include any number and type of processing units or modules that may provide control and other high level functions for system 1200 and/or provide any operations as discussed herein. Memory 1203 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 1203 may be implemented by cache memory.

In an implementation, one or more or portions of at least the cross-channel control unit 1208, encode control unit 1212, and simultaneous encode units 1216, 1218, 1220, 1222, to 1224 are implemented via an execution unit (EU). The EU may include, for example, programmable logic or circuitry such as a logic core or cores that may provide a wide array of programmable logic functions. In an implementation, one or more or portions of cross-channel control unit 1208, encode control unit 1212, and simultaneous encode units 1216, 1218, 1220, 1222, to 1224 are implemented via dedicated hardware such as fixed function circuitry or the like including MACs to operate the CC NC enhancement unit for example. Fixed function circuitry may include dedicated logic or circuitry and may provide a set of fixed function entry points that may map to the dedicated logic for a fixed purpose or function.

Various components of the systems described herein may be implemented in software, firmware, and/or hardware and/or any combination thereof. For example, various components of the systems or devices discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

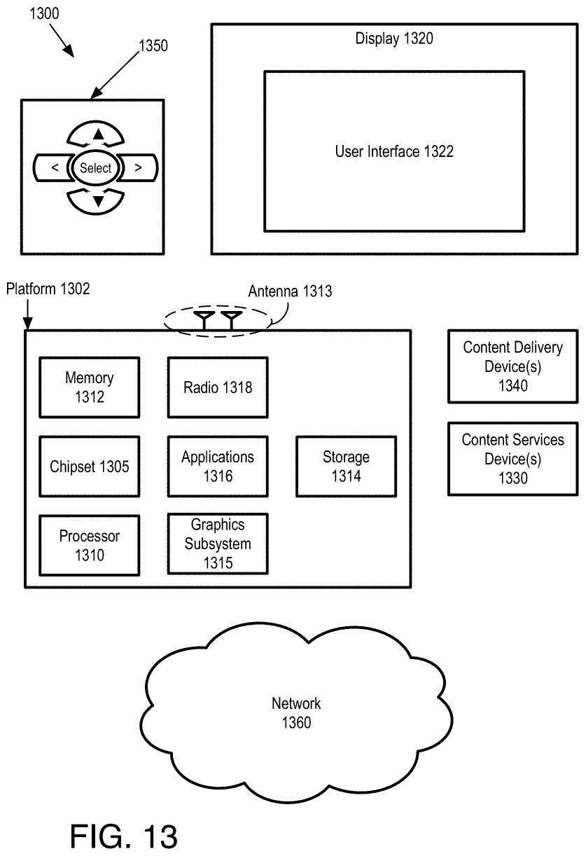

FIG. 13 is an illustrative diagram of an example system 1300, arranged in accordance with at least some implementations of the present disclosure. In various implementations, system 1300 may be a mobile system although system 1300 is not limited to this context. For example, system 1300 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1300 includes a platform 1302 coupled to a display 1320. Platform 1302 may receive content from a content device such as content services device(s) 1330 or content delivery device(s) 1340 or other similar content sources. A navigation controller 1350 including one or more navigation features may be used to interact with, for example, platform 1302 and/or display 1320. Each of these components is described in greater detail below.

In various implementations, platform 1302 may include any combination of a chipset 1305, processor 1310, memory 1312, antenna 1313, storage 1314, graphics subsystem 1315, applications 1316 and/or radio 1318. Chipset 1305 may provide intercommunication among processor 1310, memory 1312, storage 1314, graphics subsystem 1315, applications 1316 and/or radio 1318. For example, chipset 1305 may include a storage adapter (not depicted) capable of providing intercommunication with storage 1314.

Processor 1310 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1310 may be dual-core processor(s), dual-core mobile processor(s), and so forth.

Memory 1312 may be implemented as a volatile memory device such as, but not limited to, a Random Access Memory (RAM), Dynamic Random Access Memory (DRAM), or Static RAM (SRAM).

Storage 1314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1314 may include technology to increase the storage performance enhanced protection for valuable digital media when multiple hard drives are included, for example.

Graphics subsystem 1315 may perform processing of images such as still or video for display. Graphics subsystem 1315 may be a graphics processing unit (GPU) or a visual processing unit (VPU), for example. An analog or digital interface may be used to communicatively couple graphics subsystem 1315 and display 1320. For example, the interface may be any of a High-Definition Multimedia Interface, DisplayPort, wireless HDMI, and/or wireless HD compliant techniques. Graphics subsystem 1315 may be integrated into processor 1310 or chipset 1305. In some implementations, graphics subsystem 1315 may be a stand-alone device communicatively coupled to chipset 1305.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further implementations, the functions may be implemented in a consumer electronics device.

Radio 1318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1318 may operate in accordance with one or more applicable standards in any version.

In various implementations, display 1320 may include any television type monitor or display. Display 1320 may include, for example, a computer display screen, touch screen display, video monitor, television-like device, and/or a television. Display 1320 may be digital and/or analog. In various implementations, display 1320 may be a holographic display. Also, display 1320 may be a transparent surface that may receive a visual projection. Such projections may convey various forms of information, images, and/or objects. For example, such projections may be a visual overlay for a mobile augmented reality (MAR) application. Under the control of one or more software applications 1316, platform 1302 may display user interface 1322 on display 1320.

In various implementations, content services device(s) 1330 may be hosted by any national, international and/or independent service and thus accessible to platform 1302 via the Internet, for example. Content services device(s) 1330 may be coupled to platform 1302 and/or to display 1320. Platform 1302 and/or content services device(s) 1330 may be coupled to a network 1360 to communicate (e.g., send and/or receive) media information to and from network 1360. Content delivery device(s) 1340 also may be coupled to platform 1302 and/or to display 1320.

In various implementations, content services device(s) 1330 may include a cable television box, personal computer, network, telephone, Internet enabled devices or appliance capable of delivering digital information and/or content, and any other similar device capable of uni-directionally or bi-directionally communicating content between content providers and platform 1302 and/display 1320, via network 1360 or directly. It will be appreciated that the content may be communicated uni-directionally and/or bi-directionally to and from any one of the components in system 1300 and a content provider via network 1360. Examples of content may include any media information including, for example, video, music, medical and gaming information, and so forth.

Content services device(s) 1330 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1302 may receive control signals from navigation controller 1350 having one or more navigation features. The navigation features of may be used to interact with user interface 1322, for example. In various implementations, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1320) by movements of a pointer, cursor, focus ring, or other visual indicators displayed on the display. For example, under the control of software applications 1316, the navigation features located on navigation may be mapped to virtual navigation features displayed on user interface 1322, for example. In various implementations, may not be a separate component but may be integrated into platform 1302 and/or display 1320. The present disclosure, however, is not limited to the elements or in the context shown or described herein.

In various implementations, drivers (not shown) may include technology to enable users to instantly turn on and off platform 1302 like a television with the touch of a button after initial boot-up, when enabled, for example. Program logic may allow platform 1302 to stream content to media adaptors or other content services device(s) 1330 or content delivery device(s) 1340 even when the platform is turned “off.” In addition, chipset 1305 may include hardware and/or software support for 5.1 surround sound audio and/or high definition 13.1 surround sound audio, for example. Drivers may include a graphics driver for integrated graphics platforms. In various implementations, the graphics driver may include a peripheral component interconnect (PCI) Express graphics card.

In various implementations, any one or more of the components shown in system 1300 may be integrated. For example, platform 1302 and content services device(s) 1330 may be integrated, or platform 1302 and content delivery device(s) 1340 may be integrated, or platform 1302, content services device(s) 1330, and content delivery device(s) 1340 may be integrated, for example. In various implementations, platform 1302 and display 1320 may be an integrated unit. Display 1320 and content service device(s) 1330 may be integrated, or display 1320 and content delivery device(s) 1340 may be integrated, for example. These examples are not meant to limit the present disclosure.

In various implementations, system 1300 may be implemented as a wireless system, a wired system, or a combination of both. When implemented as a wireless system, system 1300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 13.

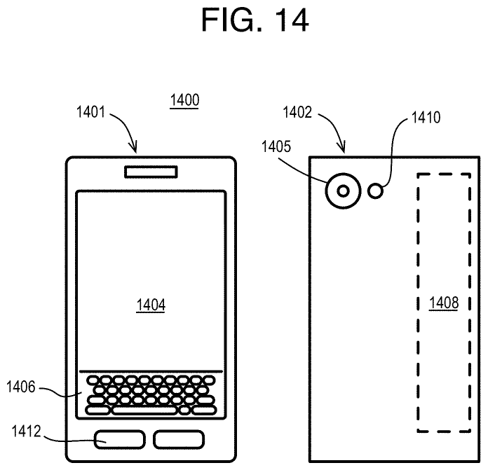

As described above, system 1200 or 1300 may be embodied in varying physical styles or form factors. FIG. 14 illustrates an example small form factor device 1400, arranged in accordance with at least some implementations of the present disclosure. In some examples, system 1200 or 1300 may be implemented via device 1400. In other examples, system 200, 300, or portions thereof may be implemented via device 1400. In various implementations, for example, device 1400 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computer, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 14, device 1400 may include a housing with a front 1401 and a back 1402. Device 1400 includes a display 1404, an input/output (I/O) device 1406, and an integrated antenna 1408. Device 1400 also may include navigation features 1412. I/O device 1406 may include any suitable I/O device for entering information into a mobile computing device. Examples for I/O device 1406 may include an alphanumeric keyboard, a numeric keypad, a touch pad, input keys, buttons, switches, microphones, speakers, voice recognition device and software, and so forth. Information also may be entered into device 1400 by way of microphone (not shown), or may be digitized by a voice recognition device. As shown, device 1400 may include one or more cameras 1405 (e.g., including a lens, an aperture, and an imaging sensor) and a flash 1410 integrated into back 1402 (or elsewhere) of device 1400. In other examples, camera 1405 and flash 1410 may be integrated into front 1401 of device 1400 or both front and back cameras may be provided. Camera 1405 and flash 1410 may be components of a camera module to originate image data processed into streaming video that is output to display 1404 and/or communicated remotely from device 1400 via antenna 1408 for example.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as IP cores, may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In one or more first implementations, a device for video coding comprises memory to store at least one video; and at least one processor communicatively coupled to the memory and being arranged to operate by:

The following examples pertain to additional implementations.

By an example one or more first implementations, a device for video coding comprises memory to store at least one video; and at least one processor communicatively coupled to the memory and being arranged to operate by: generating multiple videos of the same image content from an original video wherein at least two of the multiple videos have different frame rates; encoding concurrent frames of one of the two videos respectively concurrent to source frames of the other of the two videos comprising using at least one encode control that restricts encode decisions at the concurrent frame depending on encode decisions previously established at a corresponding source frame; and encoding non-concurrent frames of the one video that do not have a corresponding frame on the other video comprising interpolating prediction data of at least one frame of the one video to form interpolated prediction data of the non-concurrent frame, wherein the prediction data of the at least one frame directly or indirectly depends on the at least one encode control of at least one concurrent frame.

By one or more second implementation, and further to the first implementation, the at least one frame is a reference frame of the non-concurrent frame, and wherein the interpolating comprises detecting motion from the at least one frame to another frame in the one video to form the prediction data of the at least one frame.

By one or more third implementations, and further to the second implementation, wherein the another frame is a frame on an opposite side of the non-concurrent frame relative to the at least one frame and in display order and is not limited to being a designated direct reference frame of the non-concurrent frame in a group of pictures (GOPs) having the non-concurrent frame.

By one or more fourth implementations, and further to any of the first to third implementation, wherein the at least one frame is a concurrent frame that used the at least one encode control to generate the prediction data of the at least one frame.

By one or more fifth implementations, and further to any of the first to third implementation, wherein the at least one frame is a prior non-concurrent frame in encoding order, and the at least one processor being arranged to operate by generating the prediction data of the at least one frame by using prediction data of a concurrent frame using the at least one encode control.

By one or more sixth implementations, and further to any of the first to fifth implementation, wherein the interpolating comprises modifying the magnitude of motion vectors of the at least one frame.

By one or more seventh implementations, and further to any of the first to fifth implementation, wherein the interpolating comprises modifying the magnitude of motion vectors of the at least one frame, and wherein the interpolating comprises modifying the motion vectors to set the prediction data of the non-concurrent frame even when the motion vector of the at least one frame points to an intra block on another frame of the one video.

By one or more eighth implementations, and further to any of the first to fifth implementation, wherein the interpolating comprises modifying the magnitude of motion vectors of the at least one frame, and wherein the interpolating comprises modifying the motion vectors to set the prediction data of the non-concurrent frame even when the motion vector of the at least one frame points to an intra block on another frame of the one video, and wherein the interpolating comprises using hierarchical motion estimation (HME) when the motion vector of the at least one frame points to an intra block on another frame of the one video.

By one or more ninth implementations, and further to any of the first to eighth implementation, wherein the interpolating comprises detecting a flat region on image content of the at least one frame; and using a representative motion vector of the flat region to form prediction data of the non-concurrent frame.

By one or more tenth implementations, and further to any of the first to ninth implementation, wherein the method comprising, wherein the at least one processor is arranged to operate by: performing hierarchical motion estimation inter-prediction on the at least one frame to generate the interpolated prediction data of the non-concurrent frame; and when the interpolated prediction data of different hierarchy levels of the same block of the at least one frame are considered sufficiently different, at least one of: disabling the use of at least one encode control on a current block of the non-concurrent frame to be assigned the interpolated prediction data, and changing the interpolated magnitude of a interpolated prediction data motion vector depending on a difference of motion vector magnitudes from the different hierarchy levels.

By one or more eleventh implementations, and further to any of the first to tenth implementation, wherein the at least one processor being arranged to operate by confirming the interpolated prediction data is sufficiently correct comprising performing hierarchical motion estimation on the non-concurrent frame and the at least one frame, and determining whether the distortion of prediction data between hierarchical levels on the at least one frame is sufficiently close to the distortion of prediction data of the non-concurrent frame.

By one or more twelfth implementations, and further to any of the first to eleventh implementation, wherein the device comprises the at least one processor being arranged to operate by using neighbor block motion vectors of blocks on the at least one frame to perform the interpolation when intra blocks of the at least one frame are removed when forming the non-concurrent frame due to motion of image content from the at least one frame to the non-concurrent frame.

By one or more thirteenth implementations, and further to any of the first to twelfth implementations, wherein the at least one processor being arranged to operate by determining whether one or more undersampled inter-prediction blocks of the non-concurrent frame exist that do not have an incoming motion vector, or one or more oversampled inter-prediction blocks exist that have more than one incoming motion vector; and when undersampled or oversampled blocks exist, setting prediction modes different from default prediction modes.

By one or more fourteenth implementations, and further to any of the first to thirteenth implementation, wherein the at least one processor being arranged to operate by encoding the non-concurrent frames of the one video comprising setting at least one prediction mode depending on the detection of at least one intermediate region indicating motion on the non-concurrent frame from blocks moving in display order between the at least one frame and another frame of the one video.

By one or more fifteenth implementation, and further to the fourteenth implementation, wherein the at least one processor being arranged to operate by determining whether to apply interpolation or setting of the at least one prediction mode depending on whether one or more blocks of the non-concurrent frame are undersampled, wherein the undersampled individual blocks do not have any incoming interpolated motion vectors and are not intra blocks.

By an example sixteenth implementation, a computer-implemented method of video coding comprises generating multiple videos of the same image content from an original video wherein at least two of the multiple videos have different frame rates; encoding concurrent frames of one of the two videos respectively concurrent to source frames of the other of the two videos comprising using at least one encode control that restricts encode decisions at the concurrent frame depending on encode decisions previously established at a corresponding source frame; and encoding non-concurrent frames of the one video that do not have a corresponding frame on the other video comprising setting at least one prediction mode depending on the detection of at least one intermediate region indicating motion on the non-concurrent frame from blocks moving in display order between two reference frames of the one video, wherein at least one of the two reference frames has block positions of the motion region directly or indirectly depending on the at least one encode control.

By one or more seventeenth implementation, and further to the sixteenth implementation, wherein at least one of the two reference frames is a concurrent frame or a prior non-concurrent frame that has block locations and image data that depend on data of a concurrent frame.

By one or more eighteenth implementations, and further to any of the sixteenth to seventeenth implementation, wherein the at least one frame is a reference frame of the non-concurrent frame and designated in a group of pictures (GOPs) of the one video.

By one or more nineteenth implementations, and further to any of the sixteenth to eighteenth implementation, wherein the setting of at least one prediction mode comprises expanding block sizes of prediction mode candidates to block sizes at and between the block sizes of the coding units of the two reference frames that are being matched.

By one or more twentieth implementations, and further to any of the sixteenth to nineteenth implementation, wherein the setting of at least one prediction mode comprises at least one of: changing transform block sizes, performing a full block search, and adding intra-prediction modes.

By one or more twenty-first implementations, and further to any of the sixteenth to twentieth implementation, the method comprising encoding non-concurrent frames of the one video that do not have a corresponding frame on the other video comprising interpolating prediction data of at least one frame of the one video to form interpolated prediction data of the non-concurrent frame.

By one or more twenty-second implementation, at least one non-transitory computer-readable medium having stored instructions thereon that when executed cause a computing device to operate by generating multiple videos of the same image content from an original video wherein at least two of the multiple videos have different frame rates; encoding concurrent frames of one of the two videos respectively concurrent to source frames of the other of the two videos comprising using at least one encode control that restricts encode decisions at the concurrent frame depending on encode decisions previously established at a corresponding source frame; performing motion detection to form motion data that indicates motion of blocks of image data between pairs of reference frames on the one video; interpolating prediction data of one of the pair of reference frames to form prediction data of a non-concurrent frame of the one video without a corresponding frame on the other video, and depending on the magnitude and direction of the motion data; and determining whether to: (1) set the prediction mode candidate options of an intermediate motion region on the non-concurrent frame between the pair of reference frames, or (2) use the interpolated prediction data, wherein the determining depends on the interpolated prediction data.

By one or more twenty-third implementation, and further to the twenty-second implementation, wherein determining between (1) and (2) comprises determining whether one or more blocks of the non-concurrent frame are undersampled so that the blocks do not have incoming interpolated motion vectors and are not intra blocks.

By one or more twenty-fourth implementation, and further to the twenty-second implementation, wherein determining between (1) and (2) comprises determining whether one or more blocks of the non-concurrent frame are undersampled so that the blocks do not have incoming interpolated motion vectors and are not intra blocks, and wherein the (1) set prediction modes is selected when a block is undersampled.

By one or more twenty-fifth implementation, and further to the twenty-second implementation, wherein determining between (1) and (2) comprises determining whether one or more blocks of the non-concurrent frame are undersampled so that the blocks do not have incoming interpolated motion vectors and are not intra blocks, and wherein the (1) set prediction modes is selected when a block is undersampled, and wherein the determination is applied frame by frame to all blocks of the frame depending on whether or not a non-concurrent frame has at least a threshold number of undersampled blocks or threshold undersampled area size.

In one or more twenty-sixth implementations, at least one machine readable medium includes a plurality of instructions that in response to being executed on a computing device, cause the computing device to perform a method according to any one of the above implementations.

In one or more twenty-seventh implementations, an apparatus may include means for performing a method according to any one of the above implementations.

It will be recognized that the implementations are not limited to the implementations so described, but can be practiced with modification and alteration without departing from the scope of the appended claims. For example, the above implementations may include specific combination of features. However, the above implementations are not limited in this regard and, in various implementations, the above implementations may include the undertaking only a subset of such features, undertaking a different order of such features, undertaking a different combination of such features, and/or undertaking additional features than those features explicitly listed. The scope of the implementations should, therefore, be determined with reference to the appended claims, along with the full scope of equivalents to which such claims are entitled.

What is claimed is:

1. A device for video coding comprising:
memory to store at least one video; and
at least one processor communicatively coupled to the memory and being arranged to operate by:
generating multiple videos of the same image content from an original video wherein at least two of the multiple videos have different frame rates;
encoding concurrent frames of one of the two videos respectively concurrent to source frames of the other of the two videos comprising using at least one encode control that restricts encode decisions at the concurrent frame depending on encode decisions previously established at a corresponding source frame; and
encoding non-concurrent frames of the one video that do not have a corresponding frame on the other video comprising interpolating prediction data of at least one frame of the one video to form interpolated prediction data of the non-concurrent frame, wherein the prediction data of the at least one frame directly or indirectly depends on the at least one encode control of at least one concurrent frame.

2. The device of claim 1, wherein the at least one frame is a reference frame of the non-concurrent frame, and wherein the interpolating comprises detecting motion from the at least one frame to another frame in the one video to form the prediction data of the at least one frame.

3. The device of claim 2 wherein the another frame is a frame on an opposite side of the non-concurrent frame relative to the at least one frame and in display order and is not limited to being a designated direct reference frame of the non-concurrent frame in a group of pictures (GOPs) having the non-concurrent frame.

4. The device of claim 1 wherein the at least one frame is a concurrent frame that used the at least one encode control to generate the prediction data of the at least one frame.

5. The device of claim 1 wherein the at least one frame is a prior non-concurrent frame in encoding order, and the at least one processor being arranged to operate by generating the prediction data of the at least one frame by using prediction data of a concurrent frame using the at least one encode control.

6. The device of claim 1, wherein the interpolating comprises modifying the magnitude of motion vectors of the at least one frame.

7. The device of claim 6, wherein the interpolating comprises modifying the motion vectors to set the prediction data of the non-concurrent frame even when the motion vector of the at least one frame points to an intra block on another frame of the one video.

8. The device of claim 7, wherein the interpolating comprises using hierarchical motion estimation (HME) when the motion vector of the at least one frame points to an intra block on another frame of the one video.

9. The device of claim 1, wherein the interpolating comprises detecting a flat region on image content of the at least one frame; and using a representative motion vector of the flat region to form prediction data of the non-concurrent frame.

10. The device of claim 1, wherein the at least one processor is arranged to operate by:
performing hierarchical motion estimation inter-prediction on the at least one frame to generate the interpolated prediction data of the non-concurrent frame; and
when the interpolated prediction data of different hierarchy levels of the same block of the at least one frame are considered sufficiently different, at least one of:
disabling the use of at least one encode control on a current block of the non-concurrent frame to be assigned the interpolated prediction data, and
changing the interpolated magnitude of a interpolated prediction data motion vector depending on a difference of motion vector magnitudes from the different hierarchy levels.

11. The device of claim 1, wherein the at least one processor being arranged to operate by confirming the interpolated prediction data is sufficiently correct comprising performing hierarchical motion estimation on the non-concurrent frame and the at least one frame, and determining whether the distortion of prediction data between hierarchical levels on the at least one frame is sufficiently close to the distortion of prediction data of the non-concurrent frame.

12. The device of claim 1, comprising the at least one processor being arranged to operate by using neighbor block motion vectors of blocks on the at least one frame to perform the interpolation when intra blocks of the at least one frame are removed when forming the non-concurrent frame due to motion of image content from the at least one frame to the non-concurrent frame.

13. The device of claim 1, wherein the at least one processor being arranged to operate by determining whether one or more undersampled inter-prediction blocks of the non-concurrent frame exist that do not have an incoming motion vector, or one or more oversampled inter-prediction blocks exist that have more than one incoming motion vector; and when undersampled or oversampled blocks exist, setting prediction modes different from default prediction modes.

14. The device of claim 1, wherein the at least one processor being arranged to operate by encoding the non-concurrent frames of the one video comprising setting at least one prediction mode depending on the detection of at least one intermediate region indicating motion on the non-concurrent frame from blocks moving in display order between the at least one frame and another frame of the one video.

15. The device of claim 14, wherein the at least one processor being arranged to operate by determining whether to apply interpolation or setting of the at least one prediction mode depending on whether one or more blocks of the non-concurrent frame are undersampled, wherein the undersampled individual blocks do not have any incoming interpolated motion vectors and are not intra blocks.

16. A computer-implemented method of video coding comprising:
generating multiple videos of the same image content from an original video wherein at least two of the multiple videos have different frame rates;
encoding concurrent frames of one of the two videos respectively concurrent to source frames of the other of the two videos comprising using at least one encode control that restricts encode decisions at the concurrent frame depending on encode decisions previously established at a corresponding source frame; and
encoding non-concurrent frames of the one video that do not have a corresponding frame on the other video comprising setting at least one prediction mode depending on the detection of at least one intermediate region indicating motion on the non-concurrent frame from blocks moving in display order between two reference frames of the one video, wherein at least one of the two reference frames has block positions of the motion region directly or indirectly depending on the at least one encode control.

17. The method of claim 16 wherein at least one of the two reference frames is a concurrent frame or a prior non-concurrent frame that has block locations and image data that depend on data of a concurrent frame.

18. The method of claim 16, wherein the at least one frame is a reference frame of the non-concurrent frame and designated in a group of pictures (GOPs) of the one video.

19. The method of claim 16, wherein the setting of at least one prediction mode comprises expanding block sizes of prediction mode candidates to block sizes at and between the block sizes of the coding units of the two reference frames that are being matched.

20. The method of claim 16, wherein the setting of at least one prediction mode comprises at least one of:
changing transform block sizes,
performing a full block search, and
adding intra-prediction modes.

21. The method of claim 16, comprising encoding non-concurrent frames of the one video that do not have a corresponding frame on the other video comprising interpolating prediction data of at least one frame of the one video to form interpolated prediction data of the non-concurrent frame.

22. At least one non-transitory machine readable medium comprising a plurality of instructions that, in response to being executed on a computing device, cause the computing device to operate by:
generating multiple videos of the same image content from an original video wherein at least two of the multiple videos have different frame rates;
encoding concurrent frames of one of the two videos respectively concurrent to source frames of the other of the two videos comprising using at least one encode control that restricts encode decisions at the concurrent frame depending on encode decisions previously established at a corresponding source frame;
performing motion detection to form motion data that indicates motion of blocks of image data between pairs of reference frames on the one video;
interpolating prediction data of one of the pair of reference frames to form prediction data of a non-concurrent frame of the one video without a corresponding frame on the other video, and depending on the magnitude and direction of the motion data; and
determining whether to: (1) set the prediction mode candidate options of an intermediate motion region on the non-concurrent frame between the pair of reference frames, or (2) use the interpolated prediction data, wherein the determining depends on the interpolated prediction data.

23. The medium of claim 22, wherein determining between (1) and (2) comprises determining whether one or more blocks of the non-concurrent frame are undersampled so that the blocks do not have incoming interpolated motion vectors and are not intra blocks.

24. The medium of claim 23, wherein the (1) set prediction modes is selected when a block is undersampled.

25. The medium of claim 24, wherein the determination is applied frame by frame to all blocks of the frame depending on whether or not a non-concurrent frame has at least a threshold number of undersampled blocks or threshold undersampled area size.
